(19) United States
(12) Patent Application Publication
(10) Pub. No.: US 2024/0144673 A1
(43) Pub. Date: May 2, 2024

(54) GENERATING USER INTERFACES DISPLAYING AUGMENTED REALITY CONTENT

(71) Applicant: Snap Inc., Santa Monica, CA (US)

(72) Inventors: Sharon Moll, Lachen (CH); Piotr Gurgul, Hergiswil (CH)

(21) Appl. No.: 18/050,360

(22) Filed: Oct. 27, 2022

(51) Int. Cl. G06V 20/10; G06T 7/20; G06T 19/00; G06V 10/764

(52) U.S. Cl. CPC G06V 20/188; G06T 7/20; G06T 19/006; G06V 10/764; G06T 2207/30188

(57) ABSTRACT

An augmented reality (AR) plant content system is provided. The AR plant content system may detect an object in a real world scene that corresponds to a plant. The AR plant content system may generate care instructions for the plant that include AR graphics that are displayed as overlays of the real world scene. The AR plant content system may also track the motion of objects in the real world scene to determine that plant care events have taken place, such as watering the plant or pruning the plant. A plant inventory may be produced that includes care instructions and a log of plant care events for plants that correspond to one or more users.

### TECHNICAL FIELD

The present disclosure relates generally to the generating user interfaces displaying augmented reality content.

### BACKGROUND

A head-worn device may be implemented with a transparent or semi-transparent display through which a user of the head-worn device can view the surrounding environment. Such devices enable a user to see through the transparent or semi-transparent display to view the surrounding environment, and to also see objects (e.g., virtual objects such as a rendering of a 2D or 3D graphic model, images, video, text, and so forth) that are generated for display to appear as a part of, and/or overlaid upon, the surrounding environment. This is typically referred to as “augmented reality” or “AR.” A head-worn device may additionally completely occlude a user's visual field and display a virtual environment through which a user may move or be moved. This is typically referred to as “virtual reality” or “VR.” As used herein, the term AR refers to either or both augmented reality and virtual reality as traditionally understood, unless the context indicates otherwise.

A user of the head-worn device may access and use a computer software application to perform various tasks or engage in an entertaining activity. To use the computer software application, the user interacts with a user interface provided by the head-worn device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of a head-worn device, in accordance with one or more examples.

FIG. 2 is a further view of the head-worn device of FIG. 1, in accordance with one or more examples.

FIG. 3 is a diagrammatic representation of a machine, in the form of a computing apparatus within which a set of instructions may be executed for causing the machine to perform any one or more of the methodologies discussed herein in accordance with one or more examples.

FIG. 4 is a diagram of an architecture including a number of computational components to generate user interfaces that display augmented reality content with respect to plants detected in a real world scene, in accordance with one or more examples.

FIG. 5 is a diagram of an architecture including a number of computational components to generate user interfaces that display augmented reality content and instructional content with respect to plants, in accordance with one or more examples.

FIG. 6 is a flow diagram of a process to determine care instructions for a plant located in a real world scene, in accordance with one or more examples.

FIG. 7 is a flow diagram of a process to activate an augmented reality content item that uses data captured by a camera of a head-worn device to generate a user interface that includes plant information overlaid on a real world scene that includes a plant, in accordance with one or more examples.

FIG. 8 is a view of a real world scene that includes a number of objects and in which a number of user interfaces that include plant information may be displayed, in accordance with one or more examples.

FIG. 9 is a block diagram illustrating details of the head-worn device of FIG. 1, in accordance with one or more examples.

FIG. 10 is a block diagram showing an example interaction system for facilitating interactions (e.g., exchanging text messages, conducting text audio and video calls, or playing games) over a network, in accordance with one or more examples.

FIG. 11 is a diagrammatic representation of a networked environment in which the present disclosure may be deployed, in accordance with one or more examples.

### DETAILED DESCRIPTION

In many augmented reality systems, users may interact with virtual objects that are displayed in their environment. An input modality that may be utilized with AR systems is hand-tracking combined with Direct Manipulation of Virtual Objects (DMVO) where a user is provided with a user interface that is displayed to the user in an AR overlay having a two-dimensional (2D) or three-dimensional (3D) rendering. The rendering is of a graphic model in 2D or 3D where virtual objects located in the model correspond to interactive elements of the user interface. In this way, the user perceives the virtual objects as objects within an overlay in the user's field of view of the real world scene while wearing the AR system, or perceives the virtual objects as objects within a virtual world as viewed by the user while wearing the AR system. To allow the user to manipulate the virtual objects, the AR system detects the user's hands and tracks their movement, location, and/or position to determine the user's interactions with the virtual objects. In various examples, augmented reality systems may also track a user's interactions with real world objects in the environment and record information related to the user's interactions with the real world objects.

In existing systems, users may access information about objects in an environment by using search engines and/or social networking functionality. For example, users may provide queries in the form of keywords that are processed by at least one of search engines or social networking functionality to provide results related to the queries. The queries can be related to performing a task with respect to one or more objects in the environment or obtaining instructions indicating how to perform the task. To illustrate, a user may want to learn how to perform maintenance on a vehicle. In these situations, the user submits a query indicating the type of maintenance to be performed and the model and year of the vehicle. In response, the user may be provided with a list of at least one of video content, image content, or text content that corresponds to the query. The user may then access the content and proceed to perform the maintenance in accordance with the instructions included in the content.

Typically, users access information about performing a task in relation to an object using a computing device, such as a mobile computing device, a smartphone, a tablet computing device, a laptop computing device, and the like. As users are performing the task, the users often shift their gaze and attention away from the instructions displayed on the computing device to perform tasks corresponding to the objects related to the instructions. Thus, in existing systems, a user is unable to both view instructions related to performing a task and the objects on which the task is being performed. This can result in errors by the user incorrectly performing tasks because of the need to shift attention back and forth between the instructions and the object related to the task. Additionally, battery resources are more quickly depleted and excess processing resources are used as a user reads and rereads text content or plays and replays audio content or video content as the user's attention frequently shifts back and forth between the instructional content being displayed on the computing device and the task being performed.

In one or more examples, implementations described herein of an augmented reality system may detect an object in a real world scene and provide users with information about the object. In at least some cases, the information provided by the augmented reality system about the object may include instructional information. In various examples, the instructional information may include augmented reality content that is overlaid on the real world scene. The instructional information may be related to performing one or more tasks with respect to the object. In these scenarios, the user accesses the instructional information while also viewing the object that is the subject of the instructional information. In this way, the user is able to avoid constantly shifting their attention from a computing device displaying the instructional content and performing a task related to the object. Instead, the user may view the object in the real world scene and perform tasks related to the object in accordance with the real world scene while also viewing the instructional information.

In one or more illustrative examples, the instructional information is related to the care of plants. In one or more examples, video content captured by a wearable device may be analyzed to identify plants located in a real world scene. For example, one or more object detection machine learning algorithms may be implemented to perform an identification process with respect to the plant to determine a class of a plant, a species of a plant, or a type of a plant that is located in a real world scene. Based on the identification of the plant, instructional information about the plant may be provided. To illustrate, watering information, light exposure information, pruning information, habitat related information, and the like may be provided to a user via the wearable device. In at least some examples, at least a portion of the instructional information may be presented as augmented reality content items displayed using the wearable device.

In various examples, an inventory of plants may be generated and stored for a given user and/or a given location. Additionally, a log of care events for the plants included in the inventory may also be generated. For example, events related to the individual plants, such as at least one of watering, pruning, or fertilizing, may be stored. In one or more examples, reminders may also be provided to users regarding care for the plants in their inventory. In one or more illustrative examples, reminders are provided to a user when watering for a plant is indicated by a watering schedule included in the information about the plant.

Other technical features may be readily apparent to one skilled in the art from the following figures, descriptions, and claims.

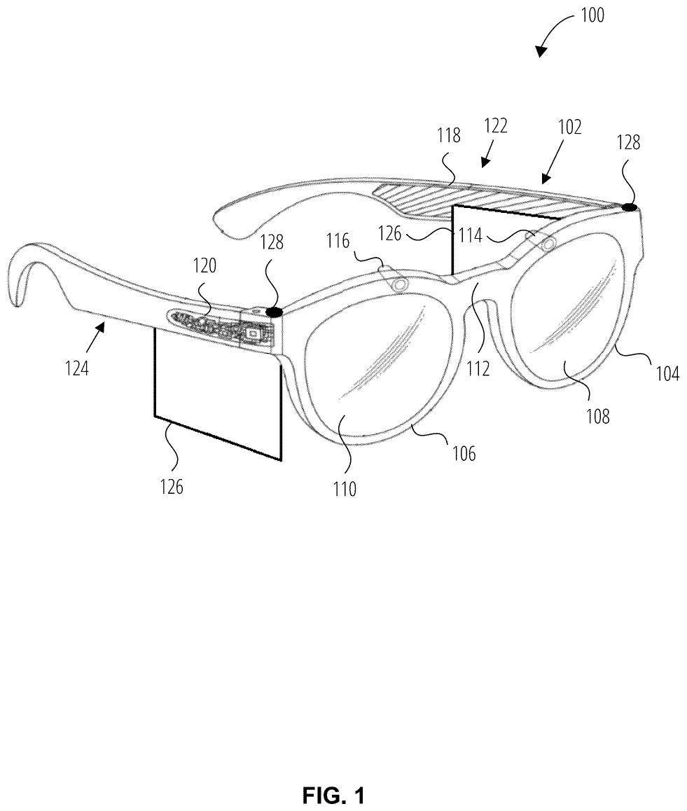

FIG. 1 is a perspective view of an AR system in a form of a head-worn device (e.g., glasses 100 of FIG. 1), in accordance with some examples. The glasses 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the glasses 100.

The frame 102 additionally includes a left arm or temple piece 122 and a right arm or temple piece 124. In some examples the frame 102 can be formed from a single piece of material so as to have a unitary or integral construction.

The glasses 100 can include a computing device, such as a computer 120, which can be of any suitable type so as to be carried by the frame 102 and, in one or more examples, of a suitable size and shape, so as to be partially disposed in one of the temple piece 122 or the temple piece 124. The computer 120 can include one or more processors with memory, wireless communication circuitry, and a power source. As discussed below, the computer 120 comprises low-power circuitry, high-speed circuitry, and a display processor. Various other examples may include these elements in different configurations or integrated together in different ways.

The computer 120 additionally includes a battery 118 or other suitable portable power supply. In some examples, the battery 118 is disposed in left temple piece 122 and is electrically coupled to the computer 120 disposed in the right temple piece 124. The glasses 100 can include a connector or port (not shown) suitable for charging the battery 118, a wireless receiver, transmitter or transceiver (not shown), or a combination of such devices.

The glasses 100 include a first or left camera 114 and a second or right camera 116. Although two cameras are depicted, other examples contemplate the use of a single or additional (i.e., more than two) cameras. In one or more examples, the glasses 100 include any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide video frame data for use by the glasses 100 to extract 3D information from a real world scene.

The glasses 100 may also include a touchpad 126 mounted to or integrated with one or both of the left temple piece 122 and right temple piece 124. The touchpad 126 is generally vertically arranged, approximately parallel to a user's temple in some examples. As used herein, generally vertically aligned means that the touchpad is more vertical than horizontal, although potentially more vertical than that. Additional user input may be provided by one or more buttons 128, which in the illustrated examples are provided on the outer upper edges of the left optical element holder 104 and right optical element holder 106. The one or more touchpads 126 and buttons 128 provide a means whereby the glasses 100 can receive input from a user of the glasses 100.

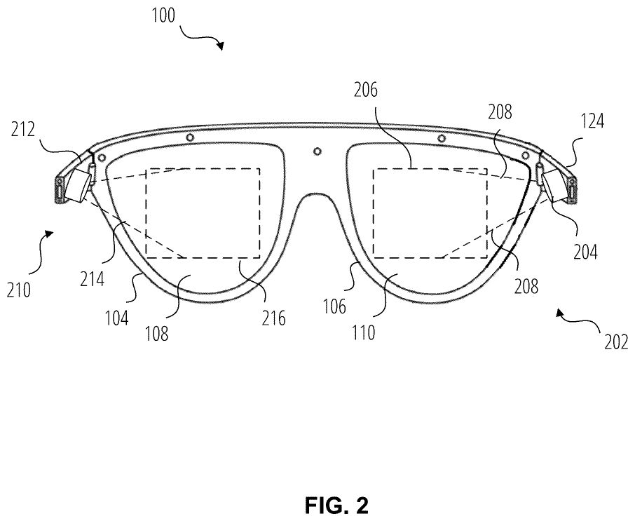

FIG. 2 illustrates the glasses 100 from the perspective of a user. For clarity, a number of the elements shown in FIG. 1 have been omitted. As described in FIG. 1, the glasses 100 shown in FIG. 2 include left optical element 108 and right optical element 110 secured within the left optical element holder 104 and the right optical element holder 106 respectively.

The glasses 100 include forward optical assembly 202 comprising a right projector 204 and a right near eye display 206, and a forward optical assembly 210 including a left projector 212 and a left near eye display 216.

In some examples, the near eye displays are waveguides. The waveguides include reflective or diffractive structures (e.g., gratings and/or optical elements such as mirrors, lenses, or prisms). Light 208 emitted by the projector 204 encounters the diffractive structures of the waveguide of the near eye display 206, which directs the light towards the right eye of a user to provide an image on or in the right optical element 110 that overlays the view of the real world scene seen by the user. Similarly, light 214 emitted by the projector 212 encounters the diffractive structures of the waveguide of the near eye display 216, which directs the light towards the left eye of a user to provide an image on or in the left optical element 108 that overlays the view of the real world scene seen by the user. The combination of a GPU, the forward optical assembly 202, the left optical element 108, and the right optical element 110 provide an optical engine of the glasses 100. The glasses 100 use the optical engine to generate an overlay of the real world scene view of the user including display of a user interface to the user of the glasses 100.

It will be appreciated however that other display technologies or configurations may be utilized within an optical engine to display an image to a user in the user's field of view. For example, instead of a projector 204 and a waveguide, an LCD, LED or other display panel or surface may be provided.

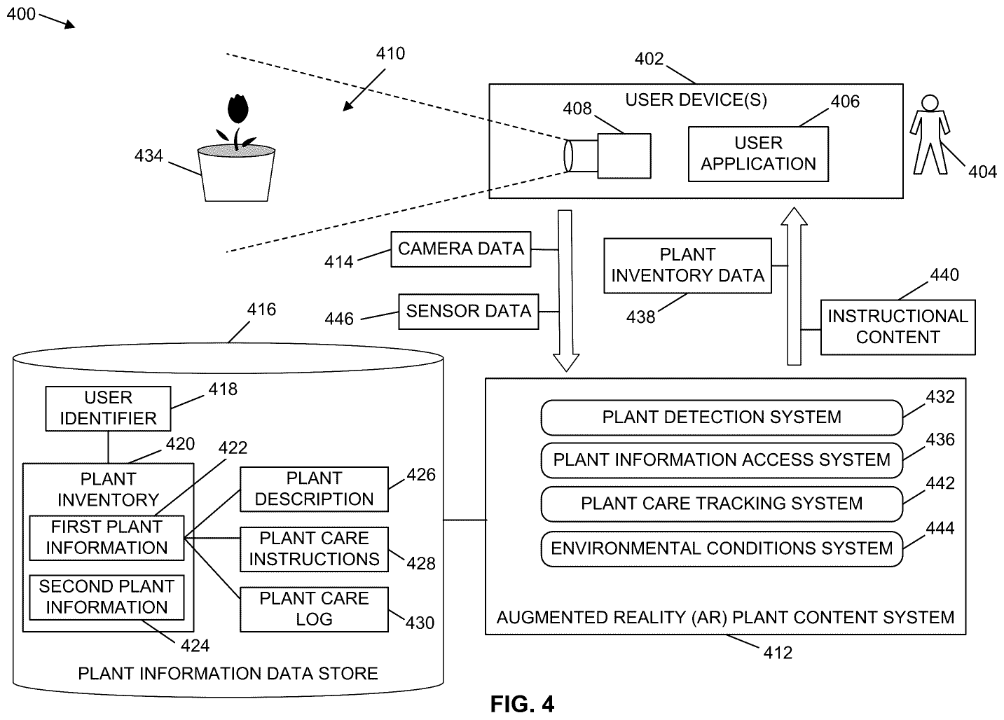

In use, a user of the glasses 100 will be presented with information, content and various user interfaces on the near eye displays. As described in more detail herein, the user can then interact with the glasses 100 using a touchpad 126 and/or the buttons 128, voice inputs or touch inputs on an associated device (e.g., user device 402 illustrated in FIG. 4), and/or hand movements, locations, and positions detected by the glasses 100.

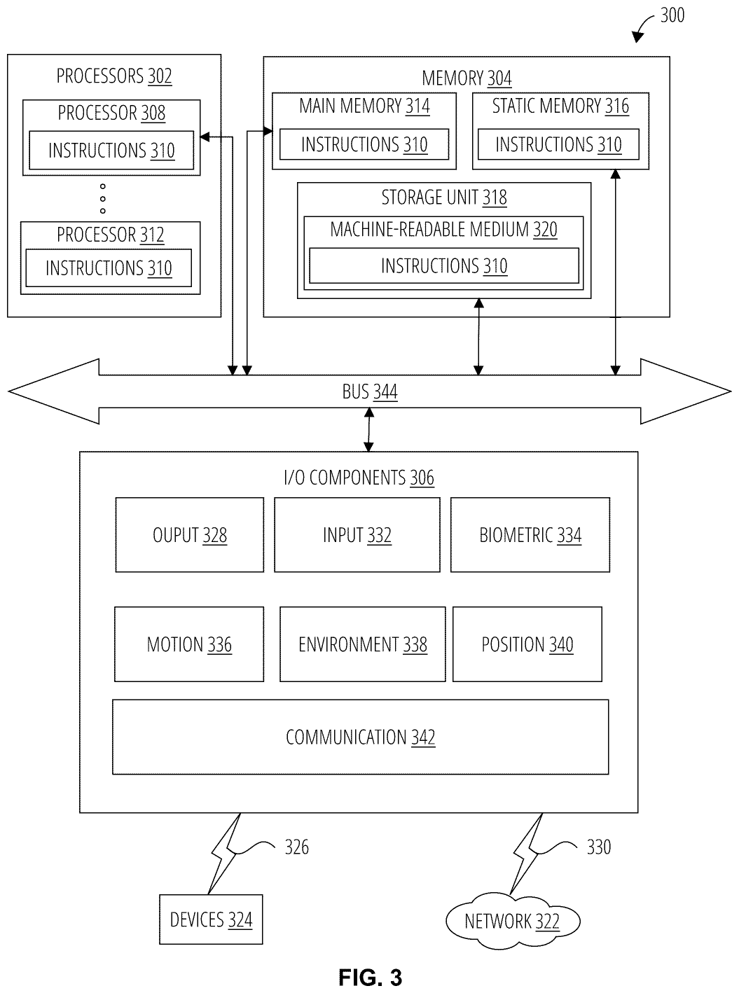

FIG. 3 is a diagrammatic representation of a computing apparatus 300 within which instructions 310 (e.g., software, a program, an application, an applet, an app, or other executable code) for causing the computing apparatus 300 to perform any one or more of the methodologies discussed herein may be executed. The computing apparatus 300 may be utilized as a computer 120 of glasses 100 of FIG. 1. For example, the instructions 310 may cause the computing apparatus 300 to execute any one or more of the methods described herein. The instructions 310 transform the general, non-programmed computing apparatus 300 into a particular computing apparatus 300 programmed to carry out the described and illustrated functions in the manner described. The computing apparatus 300 may operate as a standalone device or may be coupled (e.g., networked) to other machines. In a networked deployment, the computing apparatus 300 may operate in the capacity of a server machine or a client machine in a server-client network environment, or as a peer machine in a peer-to-peer (or distributed) network environment. The computing apparatus 300 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a head-worn device (e.g., a smart watch), a smart home device (e.g., a smart appliance), other smart devices, a web appliance, a network router, a network switch, a network bridge, or any machine capable of executing the instructions 310, sequentially or otherwise, that specify actions to be taken by the computing apparatus 300. Further, while a single computing apparatus 300 is illustrated, the term “machine” may also be taken to include a collection of machines that individually or jointly execute the instructions 310 to perform any one or more of the methodologies discussed herein.

The computing apparatus 300 may include processors 302, memory 304, and I/O components 306, which may be configured to communicate with one another via a bus 344. In some examples, the processors 302 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 308 and a processor 312 that execute the instructions 310. The term “processor” is intended to include multi-core processors that may comprise two or more independent processors (sometimes referred to as “cores”) that may execute instructions contemporaneously. Although FIG. 3 shows multiple processors 302, the computing apparatus 300 may include a single processor with a single core, a single processor with multiple cores (e.g., a multi-core processor), multiple processors with a single core, multiple processors with multiples cores, or any combination thereof.

The memory 304 includes a main memory 314, a static memory 316, and a storage unit 318, both accessible to the processors 302 via the bus 344. The main memory 304, the static memory 316, and storage unit 318 store the instructions 310 embodying any one or more of the methodologies or functions described herein. The instructions 310 may also reside, completely or partially, within the main memory 314, within the static memory 316, within machine-readable medium 320 within the storage unit 318, within one or more of the processors 302 (e.g., within the processor's cache memory), or any suitable combination thereof, during execution thereof by the computing apparatus 300.

The I/O components 306 may include a wide variety of components to receive input, provide output, produce output, transmit information, exchange information, capture measurements, and so on. The specific I/O components 306 that are included in a particular machine will depend on the type of machine. For example, portable machines such as mobile phones may include a touch input device or other such input mechanisms, while a headless server machine will likely not include such a touch input device. It will be appreciated that the I/O components 306 may include many other components that are not shown in FIG. 3. In various examples, the I/O components 306 may include output components 328 and input components 332. The output components 328 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 332 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In some examples, the I/O components 306 may include biometric components 334, motion components 336, environmental components 338, and position components 340, among a wide array of other components. For example, the biometric components 334 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 336 may include inertial measurement units, acceleration sensor components (e.g., accelerometer), gravitation sensor components, rotation sensor components (e.g., gyroscope), and so forth. The environmental components 338 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals associated to a surrounding physical environment. The position components 340 may include location sensor components (e.g., a GPS receiver component), altitude sensor components (e.g., altimeters or barometers that detect air pressure from which altitude may be derived), orientation sensor components (e.g., an Inertial Measurement Unit (IMU)), and the like.

Communication may be implemented using a wide variety of technologies. The I/O components 306 further include communication components 342 operable to couple the computing apparatus 300 to a network 322 or devices 324 via a coupling 330 and a coupling 326, respectively. For example, the communication components 342 may include a network interface component or another suitable device to interface with the network 322. In further examples, the communication components 342 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 324 may be another machine or any of a wide variety of peripheral devices (e.g., a peripheral device coupled via a USB).

Moreover, the communication components 342 may detect identifiers or include components operable to detect identifiers. For example, the communication components 342 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 342, such as location via Internet Protocol (IP) geolocation, location via Wi-Fi® signal triangulation, location via detecting an NFC beacon signal that may indicate a particular location, and so forth.

The various memories (e.g., memory 304, main memory 314, static memory 316, and/or memory of the processors 302) and/or storage unit 318 may store one or more sets of instructions and data structures (e.g., software) embodying or used by any one or more of the methodologies or functions described herein. These instructions (e.g., the instructions 310), when executed by processors 302, cause various operations to implement the disclosed examples.

The instructions 310 may be transmitted or received over the network 322, using a transmission medium, via a network interface device (e.g., a network interface component included in the communication components 342) and using any one of a number of well-known transfer protocols (e.g., hypertext transfer protocol (HTTP)). Similarly, the instructions 310 may be transmitted or received using a transmission medium via the coupling 326 (e.g., a peer-to-peer coupling) to the devices 324.

FIG. 4 is a diagram of an environment 400 including a number of computational components to generate user interfaces that display augmented reality content with respect to plants detected in a real world scene, in accordance with one or more examples. The environment 400 may include one or more user devices 402. The one or more user devices 402 may be operated by a user 404. The one or more user devices 402 may include a number of computing devices having processing resources and memory resources. For example, the one or more user devices 402 may include at least one of a head-worn device, a wearable device, or a mobile computing device, such as a smart phone, tablet computing device, laptop computing device, portable gaming device, and the like. In various examples, the one or more user devices 402 may include multiple computing devices that operate in conjunction with one another. To illustrate, the one or more user devices 402 may include a head-worn device that operates in conjunction with at least one of a wearable device or a mobile computing device. In one or more additional examples, the one or more user devices 402 may include a wearable device that operates in conjunction with a mobile computing device. In one or more illustrative examples, the one or more user devices 402 include the glasses 100 of FIG. 1.

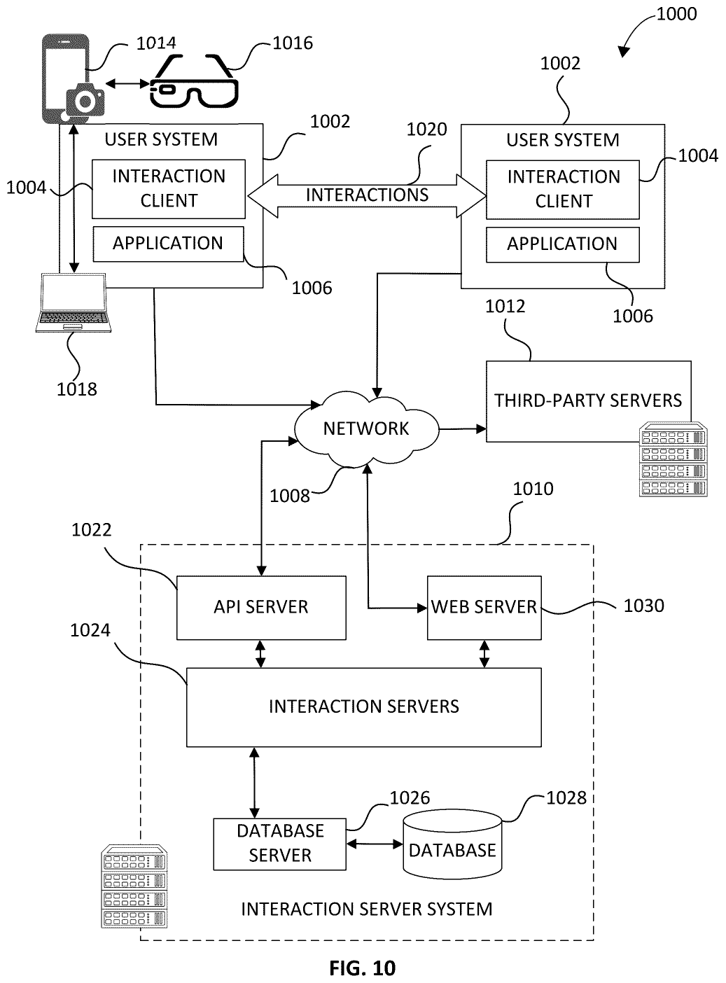

The processing resources and the memory resources of the one or more user devices 402 may execute a number of applications, such as user application 406. In one or more examples, the user application 406 may include messaging functionality that enables the user 404 to send messages to and receive messages from other users of the user application 406. In one or more additional examples, the user application 406 may include social networking functionality that enables the user 404 to share content with other users of the user application 406 and/or to access content created by other users of the user application 406. In one or more illustrative examples, the user application 406 may include at least one of the interaction client 1004 or the application 1006 described in more detail with respect to FIG. 10.

The one or more user devices 402 may also include one or more cameras, such as camera 408. Camera 408 may capture images of an environment in which the one or more user devices 402 are located. In one or more examples, the camera 408 may capture video of an environment in which the one or more user devices 402 are located. The video may comprise at least one of a series of images or a stream of images captured during a period of time. In various examples, the camera 408 may capture video of a real world scene in response to input from the user 404. The images captured by the camera 408 may be within a field of view 410 of the camera 408. The field of view 410 may correspond to a portion of an environment that may be imaged by the camera 408 at a given time and may be based on focal length of a lens of the camera 408 and a size of a sensor of the camera 408. In at least some examples, the camera 408 may capture a live/current view of a real world scene within the field of view 410. Although not shown in the illustrative example of FIG. 4, the one or more user devices 402 may also include a number of audio capture devices. To illustrate, the one or more user devices 402 may include a number of microphones to capture audio content produced in an environment in which the one or more user devices 402 are located. In one or more illustrative examples, the one or more user devices 402 include one or more microphones to capture audio content in conjunction with video content captured by the camera 408.

The environment 400 may also include an augmented reality (AR) plant content system 412. The AR plant content system 412 may generate content related to one or more objects included in the field of view 410 of the camera 408 that includes augmented reality content. In one or more examples, the content may be displayed within a real world scene captured by the camera 408. The augmented reality content may be visible via one or more display devices of the one or more user devices 402. In at least some examples, the augmented reality graphics may not be visible outside of the one or more display device of the one or more user devices 402, while the objects included in the real world scene captured within the field of view 410 are visible outside of the one or more display devices of the one or more user devices 402. Although the AR plant content system 412 is shown outside of the one or more user devices 402 in the illustrative example of FIG. 4, in one or more implementations, at least a portion of the operations performed by the AR plant content system 412 may be executed by one or more user devices 402. In one or more illustrative examples, the one or more user devices 402 may include at least a portion of the AR plant content system 412.

The augmented reality content may be generated in conjunction with an augmented reality content item. Augmented reality content items may include program code that is executable to perform one or more functions. In various examples, augmented reality content items may be executable within the user application 406. For example, an instance of the user application 406 may be activated by the one or more user devices 402 and one or more user interfaces of the user application 406 may be displayed via one or more display devices of the one or more user devices 402. Augmented reality content items may be selected while viewing one or more user interfaces of the user application 406 and executed to activate one or more functions that correspond to the selected augmented reality content item.

In one or more examples, augmented reality content items may be executable to modify an appearance of one or more objects included in the field of view 410 captured by the camera 408. In this way, the appearance of the object when modified by execution of the augmented reality content item is different than the appearance of the object otherwise. To illustrate, an augmented reality content item may be executable to modify at least one of contours, shapes, colors, sizes, textures, one or more combinations thereof, and the like of one or more objects included in the field of view 410. Additionally, an augmented reality content item may be executable to generate one or more augmented reality graphics in relation to one or more objects included in an image captured by the camera 408.

In one or more illustrative examples, an augmented reality content item is executable to cause one or more overlays to be displayed with respect to one or more objects included in the field of view 410 captured by the camera 408. Further, an augmented reality content item may be executable to generate one or more animations in relation to one or more objects included in the field of view 410 captured by the camera 408. In one or more additional illustrative examples, an augmented reality content item is executable to display information obtained from one or more sources. For example, an augmented reality content item may be executable to display instructional information about one or more objects within the field of view 410 within one or more user interfaces generated by the user application 406.

In one or more examples, the AR plant content system 412 may obtain camera data 414 generated by the camera 408. The camera data 414 may include one or more images captured by the camera 408 of a real world scene. The AR plant content system 412 may analyze the camera data 414 to detect objects within the field of view 410 of the camera 408. The AR plant content system 412 may at least one of generate or obtain instructional information related to the detected objects within the field of view 410. In at least some examples, the AR plant content system 412 may obtain additional information from the one or more user devices 402 that corresponds to the detected objects and cause the additional information to be stored in a data store for subsequent retrieval and access by the user 404. In one or more illustrative examples, the AR plant content system 412 may identify plants located in the environment 400 and provide instructional content related to the identified plants.

The environment 400 may also include a plant information data store 416 that stores information about plants related to users of the user application 406. The plant information data store 416 may be at least one of physically coupled or electronically coupled to the AR plant content system 412. In one or more examples, the plant information data store 416 may be part of a cloud-based data storage architecture. In these scenarios, a cloud-based data storage architecture is a distributed data storage scheme across a number of physical or virtual data storage devices. The information stored by the plant information data store 416 may be accessed by the AR plant content system 412 over at least one of one or more wired networks or one or more wireless networks.

The plant information data store 416 may store data related to plants of users of the user application 406 in conjunction with respective identifiers of the users. The identifiers of the users may correspond to an account of the users in relation to the user application 406. In the illustrative example of FIG. 4, information related to plants that correspond to the user 404 is stored in relation to a user identifier 418. In various examples, the user identifier 418 may uniquely identify the user 404 within the user application 406. In one or more examples, the plant information data store 416 may store a plant inventory 420 of the user 404 in conjunction with the user identifier 418. The plant inventory 420 may include information about plants of the user 404 that are located in one or more geographic locations associated with the user 404. For example, the plant inventory 420 may store information about plants located at a residence of the user 404. In one or more additional examples, the plant inventory 420 may store information about plants located at a workplace of the user 404. In one or more further examples, the plant inventory 420 may store information about plants located at a residence or a workplace of another party that is related to the user 404, such as a customer of the user 404. To illustrate, the user 404 may take care of plants of another individual that are located at a residence or workplace of the individual. In one or more examples, the plant information data store 416 may include a plurality of plant inventories of the user 404. In one or more illustrative examples, the plant information data store 416 may store a first plant inventory of the user 404 that corresponds to a first location and a second plant inventory of the user 404 that corresponds to a second location.

In the illustrative example of FIG. 4, the plant inventory 420 includes first plant information 422 that corresponds to a first plant related to the user 404 and second plant information 424 that corresponds to a second plant related to the user 404. The first plant information 422 may include a plant description 426. The plant description 426 may indicate background information of the first plant. The background information may indicate a natural habitat of the first plant, a classification of the first plant, a description of the appearance of the first plant at one or more stages of growth, toxicity information related to the first plant, soil preferences for the first plant, lighting preferences for the first plant, information about diseases to which the first plant may be susceptible, or one or more combinations thereof. In at least some examples, the plant description 426 may include one or more images of the first plant.

The plant inventory 420 may also include plant care instructions 428 of the first plant. The plant care instructions 428 may indicate an amount of light to provide to the plant. The plant care instructions 428 may also indicate an optimal temperature range for the plant and a threshold temperature or a temperature range at which the first plant may become damaged. In one or more examples, the plant care instructions 428 may indicate conditions that are conducive to the first plant becoming diseased. Additionally, the plant care instructions 428 may indicate at least one of an amount of watering for the first plant over a given period of time or a soil moisture content range for the first plant. Further, the plant care instructions 428 may indicate a watering preference for the first plant, such as watering the first plant from above, watering the first plant from below, or misting the first plant. In various examples, the plant care instructions 428 may indicate repotting information and/or information indicating instructions for changing the soil in which the first plant is located. The plant care instructions 428 may also include pruning information for the first plant. In still other examples, the plant care instructions 428 may include information corresponding to fertilization of the first plant. In at least some examples, the plant care instructions may include at least one of image content, video content, audio content, or animations that are illustrative of one or more aspects of the plant care instructions 428.

In addition, the first plant information 422 may include a plant care log 430. The plant care log 430 may indicate events related to the care of the first plant. In one or more examples, the plant care log 430 may indicate timing information for the events that took place related to the care of the first plant. For example, the plant care log 430 may indicate timing information that corresponds to watering events related to the first plant. The plant care log 430 may also indicate timing information that corresponds to pruning events related to the first plant. Additionally, the plant care log 430 may indicate an amount of direct or indirect sunlight received by the first plant over a period of time. Further, the plant care log 430 may indicate soil moisture content related to the first plant over a period of time. In at least some examples, the plant care log 430 may indicate repotting event information and/or soil change information for the first plant. In still other examples, the plant care log 430 may indicate at least one of temperature or relative humidity information for a location of the first plant over a period of time.

Although the information stored by the plant information data store 416 in the illustrative example of FIG. 4 is described with respect to a single user, in various implementations, the plant information data store 416 stores similar information with respect to multiple users of the user application 406. Additionally, although not shown in the illustrative example of FIG. 4, the second plant information 424 may include a plant description, plant care instructions, and a plant care log for the second plant.

The AR plant content system 412 may include a plant detection system 432 to detect one or more plants within the field of view 410 of the camera 408. In the illustrative example of FIG. 4, the plant detection system 432 determines that a plant 434 is located in the field of view 410. In one or more examples, the plant detection system 432 may analyze the camera data 414 to determine that the plant 434 is located in the field of view 410. For example, the plant detection system 432 may analyze the camera data 414 to determine object characteristics that include at least one of shapes, dimensions, contours, colors, or textures of objects included in the field of view 410. The plant detection system 432 may then analyze the object characteristics to identify objects within the field of view 410 that are plants. In various examples, the plant detection system 432 may implement one or more machine learning algorithms to identify objects within the field of view 410 that correspond to plants. To illustrate, the plant detection system 432 implements one or more convolutional neural networks to determine that an object included in the field of view 410 is a plant. In addition, the plant detection system 432 may implement one or more residual neural networks to determine that an object included in the field of view 410 is a plant. In one or more further examples, the plant detection system 432 may implement at least one of a k-nearest neighbor artificial neural network, a support vector machine algorithm, or a random forests algorithm to determine that an object included in the field of view 410 is a plant. In still other examples, the plant detection system 432 may implement a VGG convolutional neural network to determine that an object included in the field of view 410 is a plant. In at least some examples, one or more machine learning algorithms implemented by the plant detection system 432 to identify objects as plants may be trained according to a training data set that includes images of a number of plants having different classifications, species, types, and the like.

In various examples, the plant detection system 432 may determine a classification of plants detected in the field of view 410, such as the plant 434. For example, the plant detection system 432 may determine a classification of the plant 434 according to one or more plant classification taxonomies. In at least some examples, the plant detection system 432 may determine a species or other grouping of the plant 418. In one or more examples, the plant detection system 432 may analyze at least one of color of one or more features of the plant 434, one or more leaf features of the plant 434, one or more flower features of the plant 434, one or more dimensions of the plant 434, or one or more other organ features of the plant 434. The leaf features analyzed by the plant detection system 432 may include margin, shape, texture, color, venation, one or more combinations thereof, and the like.

The classification of the plant 434 may correspond to at least one of a species of the plant 434, a family of the plant 434, or a genus of the plant 434. In one or more examples, the plant detection system 432 may determine a classification of the plant 434 by implementing a machine learning algorithm that is different from the machine learning algorithm used to detect the plant 434 within the field of view 410. In various examples, the plant detection system 432 may implement at least one of a Naïve Bayes classification algorithm, a k-nearest neighbors classification algorithm, a support vector machine, or a random forests algorithm to determine a classification of the plant 434. Additionally, the plant detection system 432 may determine a classification of the plant 434 by implementing an artificial neural network, such as a multi-layer perceptron artificial neural network. Further, the plant detection system 432 may determine a classification of the plant 434 by implementing at least one of a recurrent neural network or a convolutional neural network. In one or more illustrative examples, the plant detection system 432 implements one or more machine learning algorithms to determine up to 1000 classes of plants, up to 10,000 classes of plants, up to 50,000 classes of plants, up to 100,000 classes of plants, or more. In various examples, the machine learning algorithms implemented by the plant detection system 432 may be trained using a training data set that includes at least 100,000 images, at least 500,000 images, at least 1 million images, at least 10 million images, at least 50 million images, up to 100 million images. In at least some scenarios, at least one of the machine learning algorithms used to determine a classification of the plant 434 is implemented by the plant detection system 432 to determine whether or not the plant 434 is diseased. In situations where a disease is detected with respect to the plant 434, the plant detection system 432 determines a classification of the disease by implementing one or more machine learning algorithms.

The AR plant content system 412 also includes a plant information access system 436. The plant information access system 436 may access information stored by the plant information data store 416 and provide the information to the one or more user devices 402. In one or more examples, the information accessed by the plant information access system 436 may be used to generate one or more user interfaces that may be displayed in conjunction with the user application 406 via one or more display devices of the one or more user devices 402.

In one or more examples, the plant information access system 436 may be invoked based on information generated by the plant detection system 432. For example, the plant detection system 432 may determine a classification of the plant 434. The plant information access system 436 may then determine, based on the class of the plant 434, whether the plant inventory 420 of the user 404 includes a plant having a same class as the plant 434. In one or more additional examples, the plant information access system 436 may determine, based on one or more images of the plant 434, whether the plant inventory 420 includes a plant having a same appearance as the plant 434. In one or more further examples, the plant information access system 436 may determine, based on location data of the plant 434, whether the plant inventory 420 includes a plant having a same or similar location as the plant 434. In various examples, the location information of the plant 434 may include at least one of real world coordinates or geographic positioning system (GPS) data that corresponds to the plant 434. In one or more illustrative examples, the plant information access system 436 may analyze at least one of a class of the plant 434 determined by the plant detection system 432, one or more images of the plant 434, or location information of the plant 434 to determine whether the plant inventory 420 includes a plant that corresponds to the plant 434.

In situations where the plant information access system determines that the plant 434 is not included in the plant inventory 420, the plant information access system 436 provides one or more options to the user 404 via the user application 406 to add the plant 434 to the plant inventory 420. For example, the user application 406 may generate one or more user interfaces that include at least one of image content, video content, or a live view of the plant 434 and one or more user interface elements that are selectable to add the plant 434 to the plant inventory 420. In response to selection of one or more user interface elements to add the plant 434 to the plant inventory 420, the plant information access system 436 obtains information about the plant 434 from one or more data sources to store in conjunction with the plant 434 in the plant inventory 420. For example, the plant information access system 436 may obtain at least a portion of plant description information and at least a portion of plant care instructions from the one or more data sources to store in the plant inventory 420 in conjunction with the plant 434. In one or more illustrative examples, the one or more data sources include at least one of the plant information data store 416, one or more additional data stores maintained or controlled by one or more entities that at least one of maintain, control, or distribute the user application 406, or one or more third-party data stores. The one or more third-party data stores may include at least one of one or more sites or one or more additional applications that provide information about plants. In one or more additional examples, the one or more third-party data sources may be accessed via one or more application programming interface (API) calls that may be used to retrieve information from the one or more third-party data sources.

In scenarios where the plant information access system 436 determines that the plant 434 is included in the plant inventory 420, the plant information access system 436 retrieves information about the plant 434 from the plant information data store 416. The plant information access system 436 may send information retrieved from the plant inventory 420 for the plant 434 to the one or more user devices 402 as plant inventory data 438. The plant inventory data 438 may be used to generate one or more user interfaces displayed in conjunction with the user application 406. The one or more user interfaces that display at least a portion of the plant inventory data 438 may include at least one of image content of the plant 434, video content of the plant 434, or a live view of the plant 434 as well as information included in the plant inventory data 438. In various examples, the plant inventory data 438 may include at least one of an identifier of the plant 434, one or more reminders relating to care of the plant 434, current soil moisture data that corresponds to the plant 434, current lighting data that corresponds to the plant 434, current temperature data the corresponds to the plant 434, current relative humidity data that corresponds to the plant 434, or a recent history of events related to the care of the plant 434.

In one or more additional examples, the plant information access system 436 may cause one or more user interfaces to be displayed in conjunction with the user application 406 that include one or more user interface elements that are selectable to access information about the plant 434. In at least some examples, the one or more user interfaces may include a list of plants included in the plant inventory 420. Individual plants included in the plant inventory may correspond to a respective user interface element that is selectable to display additional information about the selected plant. In response to selection of a user interface element related to a plant, one more user interfaces are displayed that include at least a portion of the plant description, at least a portion of the plant care instructions, or at least a portion of the plant care log. In various examples, the plant information access system 442 may send instructional content 440 to the one or more user devices 402 that include content related to caring for the plant 434. The plant information access system 436 may determine instructional content 440 to provide to the one or more user devices 402 based on a classification of the plant 434, such as at least one of a species of the plant 434, a genus of the plant 434, an order of the plant 434, or another class of the plant 434.

In one or more examples, the instructional content 440 may be displayed in one or more user interfaces of the user application 406. In one or more illustrative examples, the instructional content 440 includes information related to a frequency of watering the plant 434, an amount of water to provide to the plant, watering methods for the plant 434, a moisture content for soil in which the plant 434 is potted, or an amount of sunlight or shade that corresponds to the plant 434. In one or more additional illustrative examples, the instructional content 440 includes information related to the pruning of the plant 434. In one or more further illustrative examples, the instructional content 440 includes augmented reality content that includes at least one of one or more overlays, one or more animations, video content, or image content displayed in a real world scene that includes the plant 434. In still other illustrative examples, the instructional content 440 indicated a candidate location of the plant 434 within an environment of the user 404. The instructional content 440 may also include a recommendation to change a location of the plant 434. In at least some examples, the candidate location of the plant 434 or the recommendation to change the location of the plant 434 may be based on an amount of light incident on the plant 434 in relation to an optimal amount of light for the plant 434.

Further, the AR plant content system 412 may include a plant care tracking system 442. The plant care tracking system 442 may obtain information about events related to the care of the plant 434. In one or more examples, the plant care tracking system 442 may obtain input from the user 404 indicating one or more plant care events. For example, one or more user interfaces may be displayed via the user application 406 that include user interface elements that are selectable to indicate a plant care event for the plant 434. To illustrate, input from the user 404 via the user application 406 may indicate that the plant 434 has been watered. Additionally, input from the user 404 via the user application 406 may indicate that the plant 434 has been pruned. In still one or more examples, input from the user 404 via the user application 406 may indicate that a location of the plant 434 has been changed. In various examples, the plant care tracking system 442 may access timing information from an internal clock of the one or more user devices 402 to determine a timing of the plant care event, such as a timestamp. The plant care tracking system 442 may cause information related to plant care events to be stored in a plant care log of the plant information data store 416 that is related to the plant 434.

The plant care tracking system 442 may also analyze the camera data 414 to determine that one or more plant care events have taken place. For example, the plant care tracking system 442 may analyze the camera data 414 to identify one or more objects that may be associated with plant care events. To illustrate, the plant care tracking system 442 may analyze the camera data 414 to determine the presence of a watering implement, such as a water container, misting device, or watering wand, in the field of view 410 in conjunction with the plant 434. In response to determining that the water container is present in the field of view 410 in conjunction with the plant 434, the plant care tracking system 442 determines that a watering event has taken place with respect to the plant 434. In addition, the plant care tracking system 442 may analyze the camera data 414 to determine the presence of one or more pruning tools in the field of view 410 in conjunction with the plant 434. In response to determining that the one or more pruning tools are present in the field of view 410 with respect to the plant 434, the plant tracking system 442 determines that one or more pruning events have taken place with respect to the plant 434.

The plant care tracking system 442 may also determining that a pruning event has taken place with respect to the plant 434 by analyzing at least one of video content or image content included in the camera data 414 over a period of time. For example, the plant care tracking system 442 may analyze first image content of the plant 434 at a first time in relation to second image content of the plant 434 at a second time that is subsequent to the first time. In these situations, the plant care tracking system 442 determines differences in appearance of the plant 434 between the first image content and the second image content. The plant care tracking system 442 may then analyze the differences in the appearance of the plant 434 at the different times to determine whether or not a pruning event has taken place with respect to the plant 434. In one or more illustrative examples, the plant care tracking system 442 may determine that differences in at least one of a size of the plant 434, a shape of the plant 434, a number of leaves of the plant 434, or a number of branches of the plant 434 correspond to a pruning event taking place with respect to the plant 434.

In various examples, the plant care tracking system 442 may determine motion of the user 404 to detect one or more plant care events with respect to the plant 434. For example, the plant care tracking system 442 may analyze motion of the user 404 included in the camera data 414 to determine whether the motion corresponds to a watering event, a pruning event, a fertilizing event, a repotting event, a plant rotation event, or one or more combinations thereof. To illustrate, the plant care tracking system 442 may analyze previously captured image content and/or video content that corresponds to at least one of a watering event, a pruning event, a fertilizing event, a repotting event, or a plant rotation event, with respect to actions of the user 404 captured in the camera data 414 to determine that at least one of a watering event, a pruning event, a fertilizing event, a repotting event, or a plant rotation event has taken place with respect to the plant 434. In situations where the plant care tracking system 442 determines that actions of the user 404 included in the camera data 414 correspond to at least one of a watering event, a pruning event, a fertilizing event, a repotting event, or a plant rotation event, the plant care tracking system 442 stores information related to the plant care event in the plant care log for the plant 434.

In one or more additional examples, the plant care tracking system 442 may analyze an appearance of the plant 434 to determine whether or not a disease is present with respect to the plant 434. In various examples, the plant care tracking system 442 may analyze at least one of image content of the plant 434 or video content of the plant 434 included in the camera data 414 with respect to at least one of image content or video content of at least one of diseased plants or healthy plants having a same classification as the plant 434. In one or more illustrative examples, the plant care tracking system 442 analyzes the appearance of at least one of leaves, branches, fruit, or soil of the plant 434 to determine whether or not the plant 434 is diseased. Based on at least one or similarities or differences between the appearance of the plant 434 and the appearance of diseased and/or healthy plants having the same classification as the plant 434, the plant care tracking system 442 determines that the plant 434 is diseased. In at least some examples, the plant care tracking system 442 may determine a specified disease that is associated with the plant 434. In one or more examples, in response to determining that the plant 434 is diseased, the plant care tracking system 442 determines one or more plant care instructions to improve the health of the plant 434 and provides the plant care instructions to the user 404 via the user application 406.

In one or more illustrative examples, the plant care tracking system 442 implements one or more machine learning techniques to determine that a plant care event has taken place with respect to the plant 434 based on the camera data 414. In one or more examples, the plant care tracking system 442 may implement one or more convolutional neural networks to determine that a watering event has taken place with respect to the plant 434 based on image content of the plant 434 included in the camera data 414. Additionally, the plant care tracking system 442 may implement one or more additional convolutional neural networks to determine that a pruning event has taken place with respect to the plant 434 based on image content of the plant 434 included in the camera data 414. Further, the plant care tracking system 442 may implement one or more convolutional neural networks that include a number of convolutional layers, one or more fully connected layers, and at least one SoftMax layer to determine that an appearance of the plant 434 corresponds to a disease being present with respect to the plant 434 plant care tracking system 442 based on image data of the plant 434 included in the camera data 414.

In various examples, the plant care tracking system 442 may implement one or more machine learning models to analyze motion of one or more objects included in the camera data 414, such as a water container and a human appendage (e.g., at least one of a hands or arm of the user 404), to determine that a watering event has taken place. In still other examples, the plant care tracking system 442 may implement one or more additional machine learning models to analyze motion of one or more object included in the camera data 414, such as one or more pruning tools and at least one of a hand or arm of the user 404, to determine that a pruning event has taken place with respect to the plant 434. In at least some examples, the plant care tracking system 442 may implement one or more first machine learning models to detect a water container or pruning tools and at least one of a hand or arm of the user 404, and implement one or more second machine learning models to track the motion of the objects in relation to a plant care event.

The AR plant content system 412 may also include an environmental conditions system 444. The environmental conditions system 444 obtains and analyzes sensor data 446 from the one or more user devices 402. The sensor data 446 may include data generated by one or more light sensors of the camera 408. For example, the camera 408 may include an ambient light sensor and the one or more user devices 402 may send data generated by the ambient light sensor of the camera to the AR plant content system 412 as at least part of the sensor data 446. The environmental conditions system 444 may determine an amount of light in a location of the plant 434 based on ambient light sensor data included in the sensor data 446. The environmental conditions system 444 may then provide the information indicating the amount of light in the location of the plant 434 to the plant care tracking system 442 to determine whether the amount of light in the location of the plant 434 corresponds to an optimal amount of light for the plant 434. In various examples, the time of day may be utilized in conjunction with the amount of light determined by the environmental conditions system 444 to determine whether the location of the plant 434 provides an optimal amount of light for the plant 434.

In one or more additional examples, the one or more user devices 402 may include one or more temperature sensors that can generate data indicating a temperature of the location of the plant 434. The data generated by the one or more temperature sensors of the one or more user devices 402 may be included in the sensor data 446 obtained by the environmental conditions system 444. In one or more further examples, the one or more user devices 402 may be coupled to one or more soil moisture sensors, one or more remote temperature sensors, one or more remote relative humidity sensors, or one or more combinations thereof. In at least some examples, the one or more user devices 402 may wirelessly obtain at least one of soil moisture data, temperature data, or relative humidity data from one or more sensors located at least partially in soil where the plant is potted via one or more Bluetooth standards. The environmental conditions system 444 may provide the sensor data 446 that includes information corresponding to soil moisture conditions, temperature conditions, and/or relative humidity conditions to the plant information access system 442 to determine plant care instructions for the plant 434.

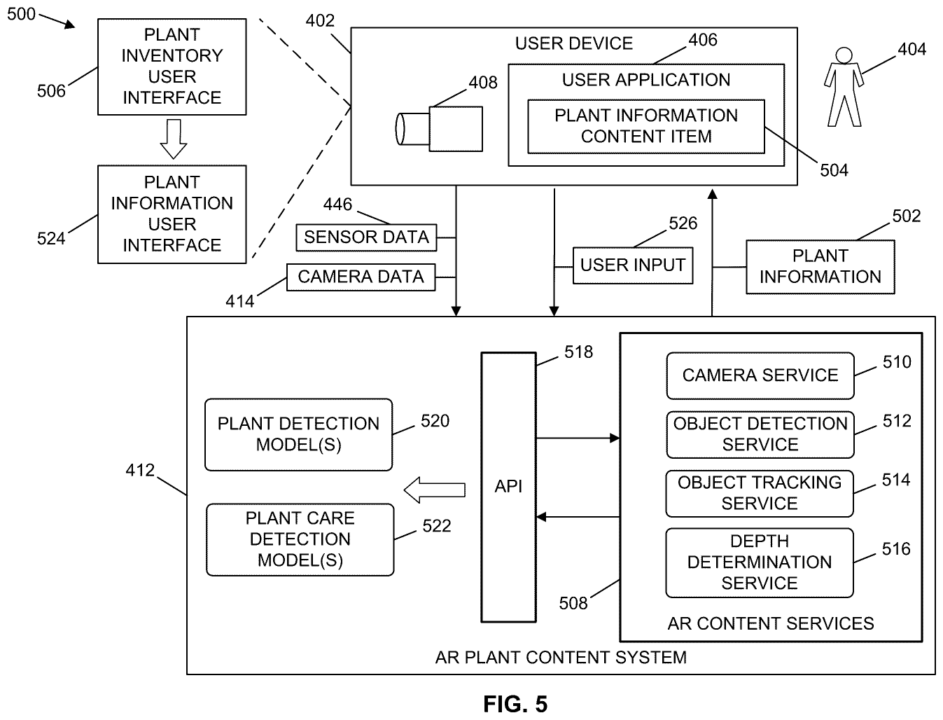

FIG. 5 is a diagram of an architecture 500 including a number of computational components to generate user interfaces that display augmented reality content and instructional content with respect to plants, in accordance with one or more examples. The architecture 500 may include a user device 402 that is operated by the user 404. The user device 402 may execute an instance of the user application 406. The user device 402 may also include the camera 408 that generates the camera data 414. The user device 402 may provide the camera data 414 to the AR plant content system 412. The AR plant content system 412 may analyze the camera data 414 to detect one or more plants located in an environment and provide instructional content related to the one or more plants. The instructional content may be related to the care of the one or more plants. In various examples, at least a portion of the operations performed by the AR plant content system 412 may be performed by the user device 402. In one or more additional examples, at least a portion of the operations performed by the AR plant content system 412 may be performed by one or more additional computing devices that are located remotely with respect to the user device 402.

The AR plant content system 412 may provide plant information 502 to the user device 402. The plant information 502 may correspond to information related to one or more plants detected in a real world scene, such as plant care information or plant inventory information. In various examples, the plant information 502 may be displayed within user interfaces generated by the user application 406. In one or more examples, the plant information 502 may be generated in conjunction with a plant information content item 504. The plant information content item 504 may include computer-readable code that is executable to activate features of the AR plant content system 412 to produce at least one of plant inventory information or plant care instructions that may be displayed in one or more user interfaces of the user application 406. For example, the plant information content item 504 may be executable to cause a listing of plants that correspond to the user 404 and/or a listing of plants included in a location to be displayed in a plant inventory user interface 506. In one or more illustrative examples, the plant information content item 504 may be executable to display a listing of plants in the plant inventory user interface 506 as an overlay of a real world scene. In one or more illustrative examples, the plant inventory user interface 506 may be displayed as an overlay of a real world scene that includes a plant listed in a plant inventory of the user 404.

The AR plant content system 412 may include AR content services 508. The AR content services 508 may perform a number of computational operations to analyze at least one of the camera data 414 or sensor data 446 in order to generate the plant information 502. In at least some examples, the AR content services 508 may implement one or more machine learning technologies. In one or more examples, the AR content services 508 may be activated in response to activation of the plant information content item 504.

The AR content services 508 may include a camera service 510 that obtains the camera data 414. For example, the camera service 510 may obtain a number of images captured by the camera 408, such as a number of video frames captured by the camera 408. In one or more examples, the camera service 510 may continuously receive the camera data 414 for a period of time. The camera service 510 may analyze video frames within a time interval, such as 0.25 seconds, 0.5 seconds, 1 second, 1.5 seconds, 2 seconds, 2.5 seconds, 3 seconds, or 5 seconds. In various examples, the camera services 510 may obtain the camera data 414 during a period of time that the plant information content item 504 is activated. In one or more additional examples, the camera service 510 may be activated and deactivated in response to user input received via the plant information content item 504. In at least some examples, the camera service 510 may make the camera data 414 available to one or more additional components of the AR content services 508.

The AR content services 508 may also include an object detection service 512. The object detection service 512 may obtain the camera data 414 from the camera service 510. In one or more examples, the object detection service 512 may analyze the camera data 414 to identify one or more objects in a real world scene. The object detection service 512 may analyze the camera data 414 to identify one or more objects that correspond to a plant care event. For example, the object detection service 512 may analyze the camera data 414 to identify a water container included in a real world scene. Additionally, the object detection service 512 may analyze the camera data 414 to identify one or more pruning tools included in a real world scene. In various examples, the object detection service 512 may analyze the camera data 414 to identify one or more plants included in a real world scene. Further, the object detection service 512 may analyze the camera data 414 to identify one or more additional objects included in a real world scene, such as a hand of the user 404, a finger of the user 404, or at least a portion of an arm of the user 404.

In one or more examples, the object detection service 512 may implement one or more artificial neural networks to analyze the camera data 414 to identify objects within a real world scene. For example, the object detection service 512 may implement one or more convolutional neural networks with respect to the camera data 414 to identify objects within a real world scene. In addition, the object detection service 512 may implement one or more classification machine learning techniques to analyze the camera data 414 to identify one or more objects in a real world scene. To illustrate, the object detection service 512 may implement one or more support vector machines with respect to the camera data 414 to identify one or more objects in a real world scene.

In one or more illustrative examples, the object detection service 512 analyzes the camera data 414 to determine a number of at least one of contours, edges, or shapes that may be used to determine one or more candidate regions that may include one or more objects of interest, such as a water container, one or more pruning tools, a plant, a finger, a hand, at least a portion of an arm, or one or more combinations thereof. The object detection service 512 may also implement a convolutional neural network to extract features from the one or more candidate regions. Additionally, the object detection service 512 may implement one or more support vector machines to classify one or more objects included in the one or more candidate regions based on the features extracted from the one or more candidate regions by the convolutional neural network. In various examples, the one or more machine learning techniques implemented by the object detection service 512 may be training using previously captured images that include one or more of the objects of interest and are labeled as including the one or more objects of interest.

The AR content services 508 may also include an object tracking service 514 that may detect movement of one or more of the objects of interest identified by the object detection service 512. In one or more examples, the object tracking service 514 may implement one or more trackers that determine movement of one or more of the objects of interest within frames of the camera data 414. In various examples, the object tracking service 514 may label an object of interest as an object to be tracked and determine differences in location of the labeled object of interest within a number of video frames. In one or more illustrative examples, the object tracking service 514 implements one or more of convolutional neural networks, recurrent neural networks, autoencoders, or generative adversarial networks to track the motion of objects of interest across video frames. In one or more additional illustrative examples, the object tracking service 514 tracks motion of a water container or motion of a pruning tool within a real world scene. In at least some examples, the object tracking service 514 may track motion of a hand and/or an arm and hand combination that is grasping a water container or a pruning tool located in a real world scene.

Additionally, the AR content services 508 may include a depth determination service 516 that determines a distance between one or more objects included in the camera data 414 and the camera 408. In various examples, the depth determination service 516 may determine coordinates in real world space for one or more objects included in a real world scene that corresponds to the camera data 414. In one or more illustrative example, the depth determination service 516 may use data obtained from multiple cameras of the user device 402 to determine the coordinates in real world space. In one or more additional illustrative examples, the depth determination service 516 implements one or more convolutional neural networks to determine coordinates in real world space for one or more objects of interest included in the camera data 414. The one or more convolutional neural networks may be trained using images including objects that have been labeled as being various distances from the one or more cameras that captured the training images.

Further, the AR plant content system 412 may implement an application programming interface (API) 518. The API 518 may include a number of calls that may be used to obtain information generated by the AR content services 508. For example, one or more first calls of the API 518 can be provided to obtain information from the camera service 510. In addition, one or more second calls of the API 518 may be provided to obtain information from the object detection service 512. Further, one or more third calls of the API 518 may be provided to obtain information from the object tracking service 514. In various examples, one or more fourth calls of the API 518 may be provided to obtain information from the depth determination service 516.

In the illustrative example of FIG. 5, calls of the API 518 provides information generated by the AR content services 508 to one or more computational models. For example, the AR plant content system 412 may include one or more plant detection models 520. The one or more plant detection models 520 may be implemented to identify one or more plants located in a real world scene based on at least one of color, shape, texture, size, or contours of objects included in the real world scene. In one or more additional examples, the one or more plant detection models 520 may be implemented to identify a classification of one or more plants included in a real world scene. In at least some examples, the one or more plant detection models 520 may use one or more calls of the API 518 to obtain information from the object detection service 512. The information obtained from the object detection service 512 by the one or more plant detection models 520 may correspond to features of plants located in a real world scene to determine respective classifications for the plants.

In addition, the AR plant content system 412 may include one or more plant care detection models 522. The one or more plant care detection models 522 may be implemented to determine one or more objects and one or more actions performed with respect to the objects that correspond to plant care events, such as watering a plant, pruning a plant, fertilizing a plant, repotting a plant, or rotating a plant. For example, the one or more plant care detection models 522 may user one or more calls of the API 518 to obtain information from the object detection service 512 indicating a watering implement or a pruning tool in a real world scene. Additionally, the one or more plant care detection models 522 may use one or more calls of the API 518 to obtain information from the object detection service 512 indicating a hand grasping a watering implement or a pruning tool. In at least some examples, the one or more plant care detection models 522 may use one or more calls of the API 518 to obtain information from the object detection service 512 indicating an arm coupled to a hand grasping a watering implement or pruning tool. Further, the one or more plant care detection models 522 may use one or more calls of the API 518 to obtain information from the object tracking service 514 to determine motion of at least one of the watering implement, the pruning tool, the hand, or the hand and arm combination. The one or more plant care detection models 522 may then determine that the motion of at least one of the watering implement, the pruning tool, the hand, or the hand/arm combination corresponds to motion indicating a plant care event, such as watering a plant or pruning a plant.

In at least some examples, the one or more plant care detection models 522 may use one or more calls of the API 518 to obtain information from the depth determination service 516. The information obtained from the depth determination service 516 may indicate a distance between one or more objects related to plant care events and a plant located in a real world scene. Based on the distance between objects related to plant care events and the location of a plant, the one or more plant care detection models 522 may determine whether actions related to plant care events are taking place within a threshold proximity of a plant. In situations where actions that correspond to plant care events are taking place within a threshold proximity of a plant, the one or more plant care detection models 522 determine that a plant care event has taken place with respect to the plant. Additionally, in scenarios where multiple plants are located in a real world scene, the one or more plant care detection models 522 use one or more calls of the API 518 to determine that actions corresponding to a plant care event are taking place within a threshold proximity of one plant of the multiple plants, but not the other plants in the real world scene.

Although the one or more plant detection models 520 and the one or more plant care detection models 522 are included in the AR plant content system 412 and shown separate from the user device 402 in the illustrative example of FIG. 5, in one or more implementations, at least a portion of the operations performed by at least one of the one or more plant detection models 520 or the one or more plant care detection models 522, may be performed by the user device 402. In various examples, the architecture 500 is arranged with the use of the API 518 by the models 520, 522 to access information from the AR content services 508 in order to minimize the computing resources and memory resources utilized by the user device 402 to generate the plant inventory user interface 506 and a plant information user interface 524 that displays specific information corresponding to at least one plant included in the plant inventory. That is, since the user device 402 may include a head-worn device or a wearable device having limited processing resources and memory resources, at least a portion of the operations performed with respect to the plant information content item 504 to generate at least one of the plant inventory user interface 506 or the plant information user interface 524 may be performed using computing resources and memory resources located remotely from the user device 402 using one or more calls of the API 518. In one or more illustrative examples, at least one of the one or more plant detection models 520 or the one or more plant care detection models 522 may be stored in memory of the user device 402 while the AR content services 508 are stored and executed using computing resources and memory resources located remotely with respect to the user device 402. In these scenarios, calls of the API 518 are used to obtain information from the AR content services 508 that is utilized by at least one of the one or more plant detection models 520 or the one or more plant care detection models 522 to generate information within at least one of the plant inventory user interface 506 or the plant information user interface 524. In one or more further examples, at least one of the plant detection system 432, the plant information access system 436, the plant care tracking system 442, or the environmental conditions system 444 may include and/or implement components of at least one of the AR content services 508, the API 518, the one or more plant detection models 520, or the one or more plant care detection models 522.

In one or more examples, the AR plant content system 412 may obtain user input 526. The user input 526 may be generated in response to actions taken by the user 404 with an input tool, such as a finger or stylus. In various examples, one or more menus may be displayed in conjunction with the plant inventory user interface 506. For example, the plant inventory user interface 506 may include a number of selectable user interface elements with individual user interfaces elements corresponding to a respective plant associated with the user 404. In these scenarios, the user input 526 corresponds to selections from the one or more menus of one or more of the plants associated with the user 404. The one or more menus may be displayed in the plant inventory user interface 506 as overlays within a real world scene.

In response to the user input 526 indicating selection of a user interface element of the plant inventory user interface 506 that corresponds to a respective plant, the plant information user interface 524 is displayed that provides information related to the selected plant. For example, the plant information user interface 524 may include plant care events that have taken place with respect to the plant. The plant information user interface 524 may also include soil moisture conditions, temperature conditions, relative humidity conditions, or one or more combinations thereof, over a period of time for a location of the selected plant. Additionally, the plant information user interface 524 may include a description of the plant. Further, the plant information user interface 524 may include at least one of text content, video content, audio content, augmented reality content, or animation content related to instructions to care for the plant. In at least some examples, the plant information user interface 524 may also include one or more reminders indicating one or more upcoming plant care events. In one or more additional illustrative examples, a mesh collider may be generated for individual user interface elements included in at least one of the plant inventory user interface 506 or the plant information user interface 524 and user input 526 indicated by contact between an input device, such as a finger or stylus, with the mesh collider may perform one or more actions corresponding to the selected user interface element.

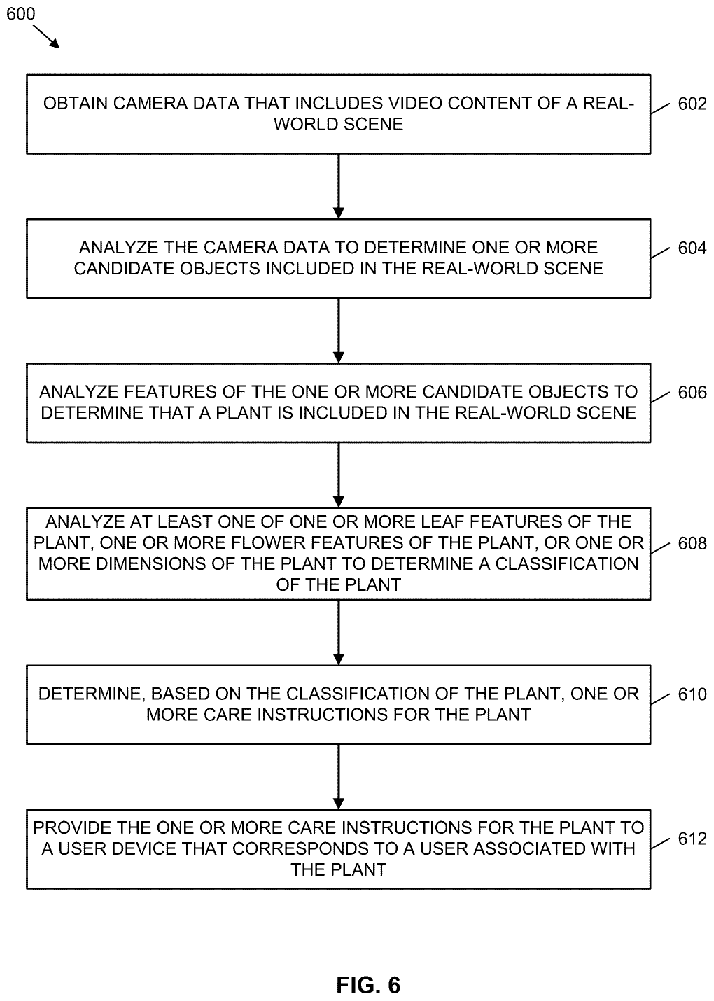

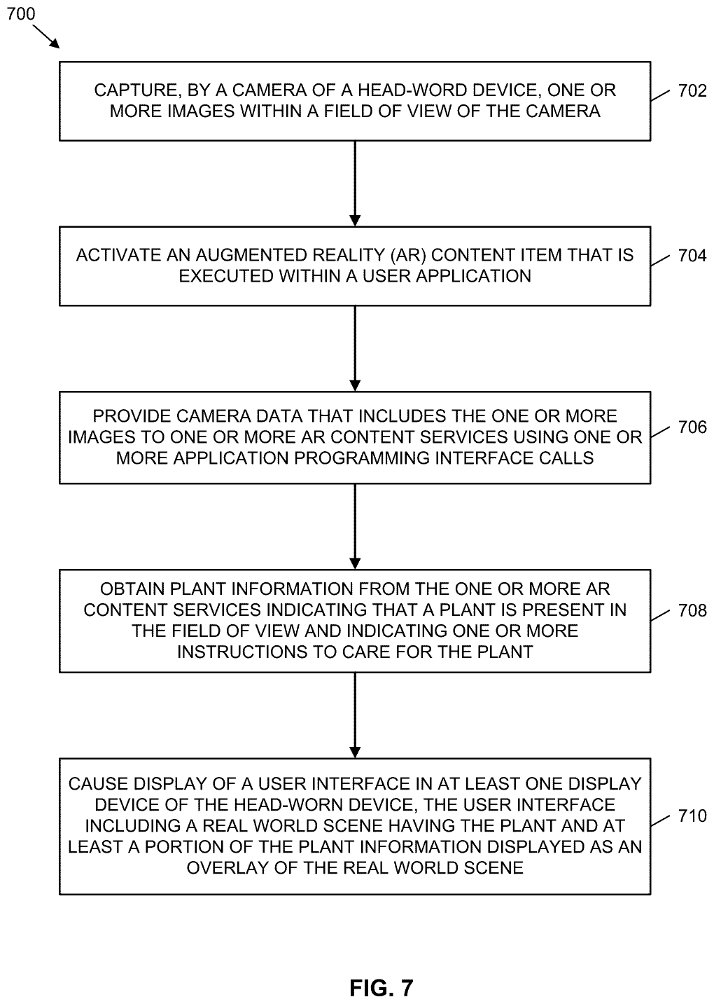

FIGS. 6 and 7 illustrate flowcharts of processes to generate AR content related to the care of plants located in a real world scene. The processes may be embodied in computer-readable instructions for execution by one or more processors such that the operations of the processes may be performed in part or in whole by the functional components of at least one of one or more client devices or one or more server systems. Accordingly, the processes described below are by way of example with reference thereto, in some situations. However, in other implementations, at least some of the operations of the processes described with respect to FIGS. 6 and 7 may be deployed on various other hardware configurations. The processes described with respect to FIGS. 6 and 7 are therefore not intended to be limited to being performed by one or more server systems or one or more client device described herein and can be implemented in whole, or in part, by one or more additional components. Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

FIG. 6 is a flow diagram of a process 600 to determine care instructions for a plant located in a real world scene, in accordance with one or more examples. The process 600 may include, at operation 602, obtaining camera data that includes video content of a real world scene. The video content may include a series of video frames captured by a camera of a user device. In one or more examples, the user device may include a head-worn device. In various examples, the camera data may include video frames captured from a plurality of cameras of a user device. The real world scene may include an indoor environment, such as a residence of a user or a workplace of a user. In one or more additional examples, the real world scene may include an outdoor environment.

At operation 604, the process 600 may include analyzing the camera data to determine one or more candidate objects or objects of interest included in the real world scene. The one or more candidate objects may be detected using one or more machine learning algorithms that have been trained to detect plants and other objects related to plants. For example, in addition to plants, the one or more candidate objects may also correspond to at least one of one or more pruning tools or one or more watering tools. The one or more pruning tools may include shears, clippers, a spade, a hoe, a rake, a hand trowel, one or more combinations thereof, and the like. The one or more watering tools may include a watering container, a hose, a watering wand, a sprayer, one or more combinations thereof, and the like.

In addition, at operation 606, the process 600 may include analyzing features of the one or more candidate objects to determine that a plant is included in the real world scene. In one or more examples, features of the one or more candidate objects may be analyzed, such as at least one of color, texture, contours, dimensions, or edges. In various examples, the one or more candidate objects may be analyzed to identify at least one of leaves, flowers, branches, plant containers, or soil. The process 600 may also include, at operation 608, analyzing at least one of leaf features of the plant, one or more flower features of the plant, colors of the plant, or one or more dimensions of the plant to determine a classification of the plant. The classification of the plant may correspond to at least one of a species of the plant, a family of the plant, a genus of the plant, or another class related to the plant.

Further, at operation 610, the process 600 may include determining, based on the classification of the plant, one or more care instructions for the plant. At operation 612, the process 600 may then include providing the one or more care instructions for the plant to a user device that corresponds to a user associated with the plant. In various examples, the one or more care instructions may be provided via an augmented reality content item that is executing in conjunction with an instance of a user application stored by the user device.

The one or more care instructions may include a frequency for watering the plant and an amount of water to provide to the plant at the given watering frequency. The one or more care instructions may also indicate that a plant is to be watered from above or watered from below. Additionally, the one or more care instructions may indicate that the plant is to be watered by misting. In at least some examples, the plant care instructions may indicate a range for moisture content of the soil in which the plant is located. In various examples, the one or more care instructions may indicate a frequency to rotate the plant and/or criteria for determining when to repot the plant. In one or more further examples, the one or more care instructions may include information about fertilization of the plant, such as a type of fertilizer to use in relation to the plant, a frequency for new fertilization of the plant, and an amount of fertilizer to use with respect to the plant.

In one or more examples, the one or more care instructions may include pruning instructions for the plant that indicate a time of year to prune the plant, an optimal appearance of the plant, a size for features of the plant, one or more combinations thereof, and so forth. In various examples, the one or more care instructions may include pruning instructions that are specific to the plant based on the appearance of the plant. For example, an appearance of the plant may be analyzed in relation to an optimal appearance for plants having the classification of the plant. Pruning instructions may then be generated to modify the current appearance of the plant to the optimal appearance of the plant. In at least some examples, the one or more care instructions may include at least one of video content, audio content, or text content. In one or more additional examples, the one or more care instructions may include augmented reality content that is displayed in relation to object in the real world scene. To illustrate, one or more animations may be displayed showing watering techniques for the plant. In one or more further examples, one or more animations may be displayed showing actions to perform to prune the plant.

In one or more examples, the appearance of the plant may be analyzed to determine that a disease is present with respect to the plant. In these instances, the one or more care instructions may indicate care instructions to treat the disease. Additionally, the one or more care instructions may include reminders to perform one or more actions to care for the plant. For example, a reminder to water the plant may be generated based on a frequency of watering included in the one or more care instructions or based on current soil moisture content of soil in which the plant is potted. Further, the one or more care instructions may correspond to an amount of ambient light available to the plant. In at least some examples, an ambient light sensor of a camera of the user device may provide ambient light data to determine an amount of ambient light available to the plant. In various examples, the one or more care instructions may indicate that the plant lacks sufficient ambient light based on the amount of ambient light measured by the ambient light sensor and the time of day. In scenarios where the amount of ambient light available to the plant is insufficient at a current location, the one or more care instructions may indicate a different location for the plant based on the amount of ambient light available to the plant at the additional location.

FIG. 7 is a flow diagram of a process 700 to activate an augmented reality content item that uses data captured by a camera of a head-worn device to generate a user interface that includes plant information overlaid on a real world scene that includes a plant, in accordance with one or more examples. At operation 702, the process 700 may include capturing, by a camera of a head-worn device, one or more images within a field of view of the camera. The head-worn device may include at least one display device that displays user interfaces viewable by a user of the head-worn device.

The process 700 may include, at operation 704, activating an augmented reality (AR) content item that is executed within a client application. For example, a user may select an icon of an augmented reality content item from a menu of augmented reality content items to activate the AR content item. In one or more illustrative examples, the AR content item may include the plant information content item 504 of FIG. 5.

In addition, at operation 706, the process 700 may include in response to activating the augmented reality content item, providing camera data that includes the one or more images to one or more AR content services using one or more application programming interface (API) calls. The camera data may correspond to the one or more images captured by the camera of the head-worn device. In various examples, the camera data may be analyzed by the one or more AR content services to generate plant information within a user interface displayed by the head-worn device.

In one or more examples, one or more API calls may be used to obtain object data that corresponds to one or more objects included in the camera data. The object data may indicate features of the one or more objects that may be analyzed using one or more plant detection models. The one or more plant detection models may be implemented to determine that the plant is present in the real world scene based on the features of an object of interest that corresponds to the plant. In one or more additional examples, the object data may be analyzed by one or more plant care detection models. The one or more plant care detection models may be implemented to determine that one or more objects of interest included in the camera data correspond to objects that are used to perform plant care activities, such as a watering implement or a pruning tool. The one or more plant care detection models may also be implemented with respect to an object tracking service to determine motion of objects that correspond to plant care activities. One or more further API calls may be used to provide the motion data to the one or more plant care detection models from the object tracking service. A combination of the presence of objects that are used in plant care activities and specified motion of the plant care objects may indicate that plant care activities with respect to the plant have occurred.

The process 700 may also include, at operation 708, obtaining the plant information from the one or more AR content services indicating that a plant is present in the field of view and indicating one or more instructions to care for the plant. In one or more examples, the camera data may be analyzed by an object detection service to determine an object of interest included in the field of view that corresponds to a plant. The object detection service may determine that a plant is present in a field of view by determining that an object of interest includes at least one of leaves, branches, or flowers. Additionally, the object detection service may determine that a plant is present in the field of view based on at least one of coloring, size, texture, or dimensions of features of the object of interest.

At operation 710, the process 700 may also include causing display of a user interface in at least one display device of the head-worn device. The user interface may include a real world scene having the plant and including at least a portion of the plant information displayed as an overlay of the real world scene. In at least some examples, the user interface may include a plant inventory indicating one or more plants that correspond to a user of the head-worn device. In these scenarios, the user interface includes user interface elements that are selectable to display additional information about one or more plants included in the plant inventory.

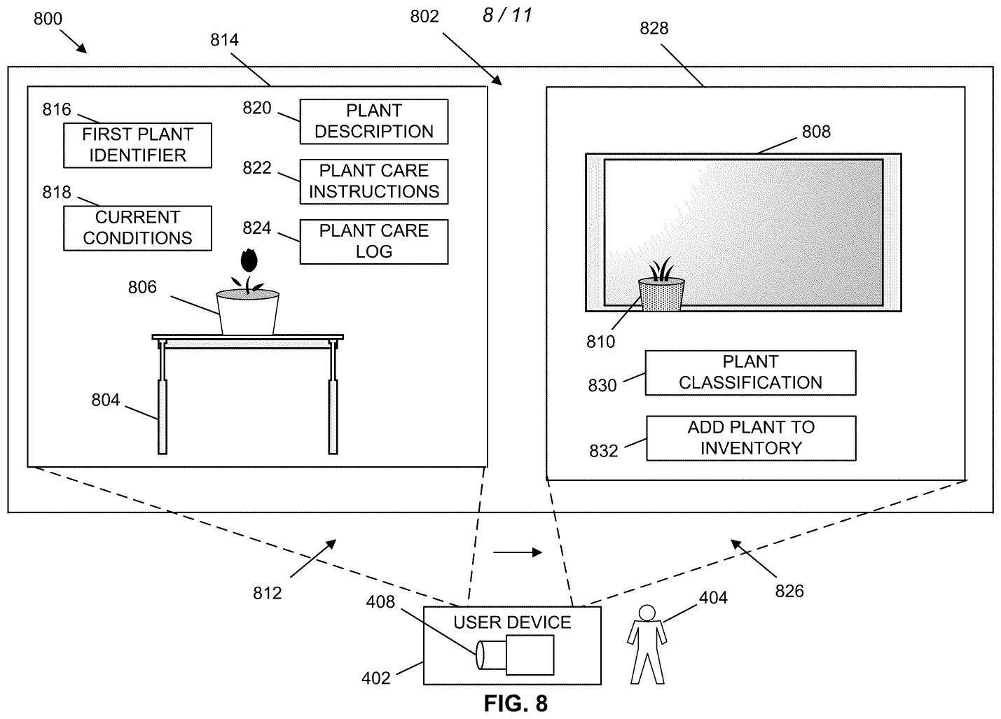

FIG. 8 is a view 800 of a real world scene 802 that includes a number of objects and in which a number of user interfaces that include plant information may be displayed, in accordance with one or more examples. In the illustrative example of FIG. 8, the real world scene 802 includes a first object that corresponds to a table 804, a second object that corresponds to a first plant 806, a third object that corresponds to a window 808, and a fourth object that corresponds to a second plant 810. The real world scene 802 may be viewed by a user 404 and camera data of the real world scene 802 may be captured by a camera 408 of a user device 402. In one or more examples, the user device 402 may include a head-worn device that is worn by the user 404. As the user moves throughout an environment, the camera 408 may continuously capture video content of the environment including the real world scene 802.

Different user interfaces may be displayed within the real world scene 802 by the user device 402 based on a field of view of the camera 408 that may correspond to a gaze of the user 404. In the illustrative example of FIG. 8, a first field of view 812 corresponds to a first location of the gaze of the user 404 that includes the table 804 and the first plant 806. A first user interface 814 may be displayed in relation to the first field of view 812. The first user interface 814 may include a number of user interface elements. The number of user interface elements included in the first user interface 814 may be determined based on the first plant 806 being included in a plant inventory of the user 404.

The first user interface 814 may include a first user interface element 816 that includes an identifier of the first plant 806. The first user interface 814 may also include a second user interface element 818 that displays current conditions related to the first plant 806. For example, the current conditions may indicate at least one of soil moisture content, temperature, or relative humidity for the first plant 806. Additionally, the current conditions may indicate a status of care for the first plant 806. To illustrate, the second user interface element 818 may display reminders indicating that one or more plant care events, such as watering the first plant 806 or rotating the first plant 806, are to be performed according to a plant care routine for the first plant 806. Further, the second user interface element 818 may display a log of plant care events that have been recently performed with respect to the first plant 806. In addition, the first user interface 814 may include a third user interface element 820 that is selectable to view a detailed description of the first plant 806, a fourth user interface element 822 that is selectable to view plant care instructions for the first plant 806, and a fifth user interface element 824 that is selectable to view a detailed plant care log for the first plant 806.

In one or more examples, the user 404 may shift their gaze, such that the field of view of the camera 408 moves from the first field of view 812 to a second field of view 826. The second field of view 826 may include the window 808 and the second plant 810. In response to the field of view of the camera 408 shifting from the first field of view 812 to the second field of view 826, a second user interface 828 may be displayed. The second user interface 828 may include a number of additional user interface elements. The number of additional user interface elements included in the second user interface 828 may be based on the second plant 810 being absent from the plant inventory of the user 404. In the illustrative example of FIG. 8, the second user interface 828 includes a sixth user interface element 830 and a seventh user interface element 832. The sixth user interface element 830 displays a classification of the second plant. In various examples, the classification of the second plant 810 may be determined by the plant detection system 432 described with respect to FIG. 4. In at least some examples, the sixth user interface element 830 may be selectable to modify the classification of the second plant 810. Additionally, the seventh user interface element 832 may be selectable to update the plant inventory of the user 404 by adding the second plant 810 to the plant inventory of the user 404. In situations where the second plant 810 is added to the plant inventory of the user 404, information about the second plant 810, such as plant care instructions, a plant description, and a plant care log, is stored in a data store, such as the plant information data store 416 described with respect to FIG. 4, in conjunction with an identifier of the user 404.

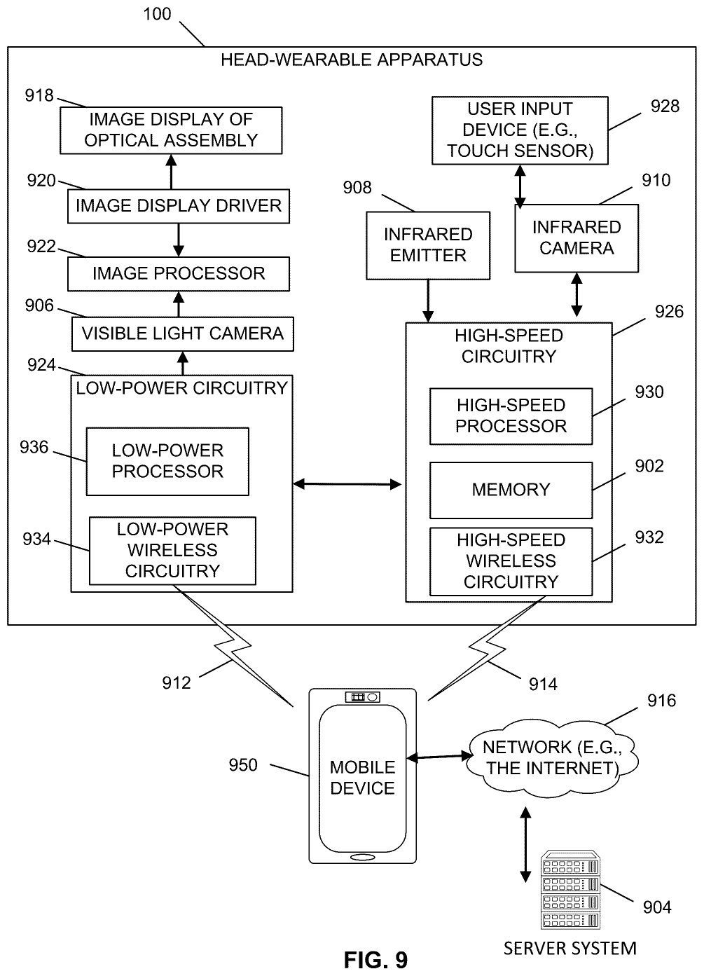

FIG. 9 is a block diagram illustrating a networked system 900 including details of the glasses 100, in accordance with some examples. FIG. 9 illustrates a system 900 including a head-wearable apparatus 100 with a selector input device, according to some examples. FIG. 9 is a high-level functional block diagram of an example head-wearable apparatus 100 communicatively coupled to a mobile device 950 and various server systems 952 (e.g., the interaction server system 1010 described with respect to FIG. 10) via various networks 916.

The head-wearable apparatus 100 includes one or more cameras, each of which may be, for example, a visible light camera 906, an infrared emitter 908, and an infrared camera 910.

The mobile device 950 connects with head-wearable apparatus 100 using both a low-power wireless connection 912 and a high-speed wireless connection 914. The mobile device 950 is also connected to the server system 904 and the network 916.

The head-wearable apparatus 100 further includes two image displays of the image display of optical assembly 918. The two image displays of optical assembly 918 include one associated with the left lateral side and one associated with the right lateral side of the head-wearable apparatus 100. The head-wearable apparatus 100 also includes an image display driver 920, an image processor 922, low-power circuitry 924, and high-speed circuitry 926. The image display of optical assembly 918 is for presenting images and videos, including an image that can include a graphical user interface to a user of the head-wearable apparatus 100.

The image display driver 920 commands and controls the image display of optical assembly 918. The image display driver 920 may deliver image data directly to the image display of optical assembly 918 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 928 (e.g., touch sensor or push button), including an input surface on the head-wearable apparatus 100. The user input device 928 (e.g., touch sensor or push button) is to receive from the user an input selection to manipulate the graphical user interface of the presented image.

The components shown in FIG. 9 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right visible light cameras 906 can include digital camera elements such as a complementary metal oxide—semiconductor (CMOS) image sensor, charge-coupled device, camera lenses, or any other respective visible or light-capturing elements that may be used to capture data, including images of scenes with unknown objects.

The head-wearable apparatus 100 includes a memory 902, which stores instructions to perform a subset or all of the functions described herein. The memory 902 can also include storage device.

As shown in FIG. 9, the high-speed circuitry 926 includes a high-speed processor 930, a memory 902, and high-speed wireless circuitry 932. In some examples, the image display driver 920 is coupled to the high-speed circuitry 926 and operated by the high-speed processor 930 in order to drive the left and right image displays of the image display of optical assembly 918. The high-speed processor 930 may be any processor capable of managing high-speed communications and operation of any general computing system needed for the head-wearable apparatus 100. The high-speed processor 930 includes processing resources needed for managing high-speed data transfers on a high-speed wireless connection 914 to a wireless local area network (WLAN) using the high-speed wireless circuitry 932. In certain examples, the high-speed processor 930 executes an operating system such as a LINUX operating system or other such operating system of the head-wearable apparatus 100, and the operating system is stored in the memory 902 for execution. In addition to any other responsibilities, the high-speed processor 930 executing a software architecture for the head-wearable apparatus 100 is used to manage data transfers with high-speed wireless circuitry 932. In certain examples, the high-speed wireless circuitry 932 is configured to implement Institute of Electrical and Electronic Engineers (IEEE) 802.11 communication standards, also referred to herein as WiFi. In some examples, other high-speed communications standards may be implemented by the high-speed wireless circuitry 932.

The low-power wireless circuitry 934 and the high-speed wireless circuitry 932 of the head-wearable apparatus 100 can include short-range transceivers (Bluetooth™) and wireless wide, local, or wide area network transceivers (e.g., cellular or WiFi). Mobile device 950, including the transceivers communicating via the low-power wireless connection 912 and the high-speed wireless connection 914, may be implemented using details of the architecture of the head-wearable apparatus 100, as can other elements of the network 916.

The memory 902 includes any storage device capable of storing various data and applications, including, among other things, camera data generated by the left and right visible light cameras 906, the infrared camera 910, and the image processor 922, as well as images generated for display by the image display driver 920 on the image displays of the image display of optical assembly 918. While the memory 902 is shown as integrated with high-speed circuitry 926, in some examples, the memory 902 may be an independent standalone element of the head-wearable apparatus 100. In certain such examples, electrical routing lines may provide a connection through a chip that includes the high-speed processor 930 from the image processor 922 or the low-power processor 936 to the memory 902. In some examples, the high-speed processor 930 may manage addressing of the memory 902 such that the low-power processor 936 will boot the high-speed processor 930 any time that a read or write operation involving memory 902 is needed.

As shown in FIG. 9, the low-power processor 936 or high-speed processor 930 of the head-wearable apparatus 100 can be coupled to the camera (visible light camera 906, infrared emitter 908, or infrared camera 910), the image display driver 920, the user input device 928 (e.g., touch sensor or push button), and the memory 902.

The head-wearable apparatus 100 is connected to a host computer. For example, the head-wearable apparatus 100 is paired with the mobile device 950 via the high-speed wireless connection 914 or connected to the server system 904 via the network 916. The server system 904 may be one or more computing devices as part of a service or network computing system, for example, that includes a processor, a memory, and network communication interface to communicate over the network 916 with the mobile device 950 and the head-wearable apparatus 100.

The mobile device 950 includes a processor and a network communication interface coupled to the processor. The network communication interface allows for communication over the network 916, low-power wireless connection 912, or high-speed wireless connection 914. Mobile device 950 can further store at least portions of the instructions for generating binaural audio content in the mobile device 950's memory to implement the functionality described herein.

Output components of the head-wearable apparatus 100 include visual components, such as a display such as a liquid crystal display (LCD), a plasma display panel (PDP), a light-emitting diode (LED) display, a projector, or a waveguide. The image displays of the optical assembly are driven by the image display driver 920. The output components of the head-wearable apparatus 100 further include acoustic components (e.g., speakers), haptic components (e.g., a vibratory motor), other signal generators, and so forth. The input components of the head-wearable apparatus 100, the mobile device 950, and server system 904, such as the user input device 928, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 100 may also include additional peripheral device elements. Such peripheral device elements may include biometric sensors, additional sensors, or display elements integrated with the head-wearable apparatus 100. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 912 and high-speed wireless connection 914 from the mobile device 950 via the low-power wireless circuitry 934 or high-speed wireless circuitry 932.

FIG. 10 is a block diagram showing an example interaction system 1000 for facilitating interactions (e.g., exchanging text messages, conducting text audio and video calls, or playing games) over a network. The interaction system 1000 includes multiple client systems 1002, each of which hosts multiple applications, including an interaction client 1004 and other applications 1006. Each interaction client 1004 is communicatively coupled, via one or more communication networks including a network 1008 (e.g., the Internet), to other instances of the interaction client 1004 (e.g., hosted on respective other user systems 1002), an interaction server system 1010 and third-party servers 1012). An interaction client 1004 can also communicate with locally hosted applications 1006 using Applications Program Interfaces (APIs).

Each user system 1002 may include multiple user devices, such as a mobile device 1014, head-wearable apparatus 1016, and a computer client device 1018 that are communicatively connected to exchange data and messages.

An interaction client 1004 interacts with other interaction clients 1004 and with the interaction server system 1010 via the network 1008. The data exchanged between the interaction clients 1004 (e.g., interactions 1020) and between the interaction clients 1004 and the interaction server system 1010 includes functions (e.g., commands to invoke functions) and payload data (e.g., text, audio, video, or other multimedia data).

The interaction server system 1010 provides server-side functionality via the network 1008 to the interaction clients 1004. While certain functions of the interaction system 1000 are described herein as being performed by either an interaction client 1004 or by the interaction server system 1010, the location of certain functionality either within the interaction client 1004 or the interaction server system 1010 may be a design choice. For example, it may be technically preferable to initially deploy particular technology and functionality within the interaction server system 1010 but to later migrate this technology and functionality to the interaction client 1004 where a user system 1002 has sufficient processing capacity.

The interaction server system 1010 supports various services and operations that are provided to the interaction clients 1004. Such operations include transmitting data to, receiving data from, and processing data generated by the interaction clients 1004. This data may include message content, client device information, geolocation information, media augmentation and overlays, message content persistence conditions, social network information, and live event information. Data exchanges within the interaction system 1000 are invoked and controlled through functions available via user interfaces (UIs) of the interaction clients 1004.

Turning now specifically to the interaction server system 1010, an Application Program Interface (API) server 1022 is coupled to and provides programmatic interfaces to interaction servers 1024, making the functions of the interaction servers 1024 accessible to interaction clients 1004, other applications 1006 and third-party server 1012. The interaction servers 1024 are communicatively coupled to a database server 1026, facilitating access to a database 1028 that stores data associated with interactions processed by the interaction servers 1024. Similarly, a web server 1030 is coupled to the interaction servers 1024 and provides web-based interfaces to the interaction servers 1024. To this end, the web server 1030 processes incoming network requests over the Hypertext Transfer Protocol (HTTP) and several other related protocols.

The Application Program Interface (API) server 1022 receives and transmits interaction data (e.g., commands and message payloads) between the interaction servers 1024 and the client systems 1002 (and, for example, interaction clients 1004 and other application 1006) and the third-party server 1012. Specifically, the Application Program Interface (API) server 1022 provides a set of interfaces (e.g., routines and protocols) that can be called or queried by the interaction client 1004 and other applications 1006 to invoke functionality of the interaction servers 1024. The Application Program Interface (API) server 1022 exposes various functions supported by the interaction servers 1024, including account registration; login functionality; the sending of interaction data, via the interaction servers 1024, from a particular interaction client 1004 to another interaction client 1004; the communication of media files (e.g., images or video) from an interaction client 1004 to the interaction servers 1024; the settings of a collection of media data (e.g., a story); the retrieval of a list of friends of a user of a user system 1002; the retrieval of messages and content; the addition and deletion of entities (e.g., friends) to an entity graph (e.g., a social graph); the location of friends within a social graph; and opening an application event (e.g., relating to the interaction client 1004).

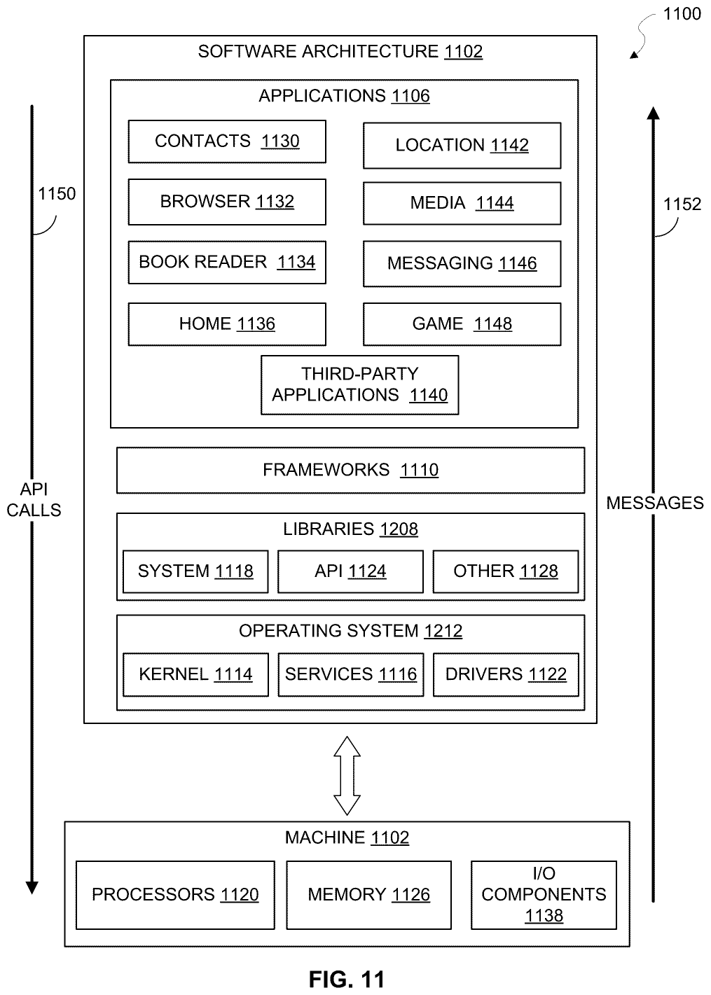

FIG. 11 is a block diagram 1100 illustrating a software architecture 1104, which can be installed on any one or more of the devices described herein. The software architecture 1104 is supported by hardware such as a machine 1102 that includes processors 1120, memory 1126, and I/O components 1138. In this example, the software architecture 1104 can be conceptualized as a stack of layers, where individual layers provide a particular functionality. The software architecture 1104 includes layers such as an operating system 1112, libraries 1108, frameworks 1110, and applications 1106. Operationally, the applications 1106 invoke API calls 1150 through the software stack and receive messages 1152 in response to the API calls 1150.

The operating system 1112 manages hardware resources and provides common services. The operating system 1112 includes, for example, a kernel 1114, services 1116, and drivers 1122. The kernel 1114 acts as an abstraction layer between the hardware and the other software layers. For example, the kernel 1114 provides memory management, processor management (e.g., scheduling), component management, networking, and security settings, among other functionalities. The services 1116 can provide other common services for the other software layers. The drivers 1122 are responsible for controlling or interfacing with the underlying hardware. For instance, the drivers 1122 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1108 provide a low-level common infrastructure used by the applications 1106. The libraries 1108 can include system libraries 1118 (e.g., C standard library) that provide functions such as memory allocation functions, string manipulation functions, mathematic functions, and the like. In addition, the libraries 1108 can include API libraries 1124 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) graphic content on a display, GLMotif used to implement user interfaces), image feature extraction libraries (e.g. OpenIMAJ), database libraries (e.g., SQLite to provide various relational database functions), web libraries (e.g., WebKit to provide web browsing functionality), and the like. The libraries 1108 can also include a wide variety of other libraries 1128 to provide many other APIs to the applications 1106.

The frameworks 1110 provide a high-level common infrastructure that is used by the applications 1106. For example, the frameworks 1110 provide various graphical user interface (GUI) functions, high-level resource management, and high-level location services. The frameworks 1110 can provide a broad spectrum of other APIs that can be used by the applications 1106, some of which may be specific to a particular operating system or platform.

In an example, the applications 1106 may include a home Application 1136, a contacts Application 1130, a browser Application 1132, a book reader Application 1134, a location Application 1142, a media Application 1144, a messaging Application 1146, a game Application 1148, and a broad assortment of other applications such as third-party applications 1140. The applications 1106 are programs that execute functions defined in the programs. Various programming languages can be employed to create one or more of the applications 1106, structured in a variety of manners, such as object-oriented programming languages (e.g., Objective-C, Java, or C++) or procedural programming languages (e.g., C or assembly language). In a specific example, the third-party applications 1140 (e.g., applications developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party applications 1140 can invoke the API calls 1150 provided by the operating system 1112 to facilitate functionality described herein.

A “carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

A “client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing some operations and may be configured or arranged in a particular physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform some operations as described herein. A hardware component may also be implemented mechanically, electronically, or any suitable combination thereof. For example, a hardware component may include dedicated circuitry or logic that is permanently configured to perform some operations. A hardware component may be a special-purpose processor, such as a field-programmable gate array (FPGA) or an application specific integrated circuit (ASIC). A hardware component may also include programmable logic or circuitry that is temporarily configured by software to perform some operations. For example, a hardware component may include software executed by a general-purpose processor or other programmable processor. Once configured by such software, hardware components become specific machines (or specific components of a machine) tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) is to be understood to encompass a tangible entity, be that an entity that is physically constructed, permanently configured (e.g., hardwired), or temporarily configured (e.g., programmed) to operate in a particular manner or to perform some operations described herein. Considering examples in which hardware components are temporarily configured (e.g., programmed), the hardware components may not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be partially processor-implemented, with a particular processor or processors being an example of hardware. For example, some of the operations of a method may be performed by one or more processors or processor-implemented components. Moreover, the one or more processors may also operate to support performance of the relevant operations in a “cloud computing” environment or as a “software as a service” (SaaS). For example, at some of the operations may be performed by a group of computers (as examples of machines including processors), with these operations being accessible via a network (e.g., the Internet) and via one or more appropriate interfaces (e.g., an API). The performance of some of the operations may be distributed among the processors, residing within a single machine as well as being deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

A “computer-readable medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

A “machine-storage medium” refers to a single or multiple storage devices and/or media (e.g., a centralized or distributed database, and/or associated caches and servers) that store executable instructions, routines and/or data. The term includes, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at some of which are covered under the term “signal medium.”

A “processor” refers to any circuit or virtual circuit (a physical circuit emulated by logic executing on an actual processor) that manipulates data values according to control signals (e.g., “commands”, “op codes”, “machine code”, and so forth) and which produces associated output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A “signal medium” refers to any intangible medium that is capable of storing, encoding, or carrying the instructions for execution by a machine and includes digital or analog communications signals or other intangible media to facilitate communication of software or data. The term “signal medium” may be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Changes and modifications may be made to the disclosed examples without departing from the scope of the present disclosure. These and other changes or modifications are intended to be included within the scope of the present disclosure, as expressed in the following claims.

What is claimed is:

1. A computing device comprising:
a camera;
one or more processors; and
memory storing instructions that, when executed by the one or more processors, cause the computing device to perform operations comprising:
capturing, by the camera, one or more images within a field of view of the camera;
activating an augmented reality (AR) content item that is executed within a client application;
in response to activating the augmented reality content item, providing camera data that includes the one or more images to one or more AR content services using one or more application programming interface (API) calls;
obtaining plant information from the one or more AR content services, the plant information indicating that a plant is present in the field of view of the camera and indicating one or more instructions to care for the plant; and
causing display of a user interface, wherein the user interface includes a real world scene having the plant and that includes at least a portion of the plant information displayed as an overlay of the real world scene.

2. The computing device of claim 1, wherein the computing device is a head-worn device that includes at least one display device and the user interface is displayed by the at least one display device.

3. The computing device of claim 1, wherein the memory stores instructions that, when executed by the one or more processors, cause the computing device to perform operations comprising:
causing a plant inventory user interface to be displayed by the user interface, the plant inventory user interface including a user interface element that corresponds to the plant and is selectable to view additional information about plant;
receiving input indicating selection of the user interface element; and
causing care instructions for the plant to be displayed in a plant information user interface, the plant information being displayed as an additional overlay of the real world scene.

4. The computing device of claim 1, wherein the one or more instructions to care for the plant include augmented reality content displayed in the real world scene.

5. The computing device of claim 1, wherein the memory stores instructions that, when executed by the one or more processors, cause the computing device to perform operations comprising:
obtaining, using one or more additional API calls, object data that corresponds to the camera data, the object data indicating features of one or more objects included in the real world scene; and
analyzing the object data using one or more plant detection models to determine that an object of the one or more objects corresponds to the plant.

6. The computing device of claim 1, wherein the memory stores instructions that, when executed by the one or more processors, cause the computing device to perform operations comprising:
obtaining, using one or more additional API calls, object data that corresponds to the camera data, the object data indicating features of one or more objects included in the real world scene; and
analyzing the object data using one or more plant care detection models to determine that the one or more objects include at least one of a watering implement or a pruning tool.

7. The computing device of claim 6, wherein the memory stores instructions that, when executed by the one or more processors, cause the computing device to perform operations comprising:
obtaining, using one or more further API calls, object motion data that corresponds to the camera data and indicates motion of at least one of the watering implement, the pruning tool, a human appendage grasping the watering implement, or a human appendage grasping the pruning tool; and
determining, using the one or more plant care detection models and based on the motion of at least one of the water container, the pruning tool, the human appendage grasping the watering implement, or the human appendage grasping the pruning tool that a plant care event has taken place with respect to the plant.

8. The computing device of claim 1, wherein the memory stores instructions that, when executed by the one or more processors, cause the computing device to perform operations comprising:
obtaining, via one or more wireless communication interfaces, sensor data from one or more sensors that are remotely located from the computing device, the sensor data indicating at least one of moisture content of soil in which the plant is located, temperature of an environment of the plant, or relative humidity of an environment of the plant;
determining, based on the sensor data, a recommendation for an action to care for the plant; and
causing an additional user interface to be displayed that includes the recommendation.

9. The computing device of claim 1, wherein the memory stores instructions that, when executed by the one or more processors, cause the computing device to perform operations comprising:
obtaining, from an ambient light sensor of the camera, sensor data indicating an amount of ambient light in an environment of the plant;
determining a time of day corresponding to the sensor data; and
determining, based on the amount of ambient light and the time of day, that the environment of the plant lacks sufficient ambient light for the plant.

10. A method comprising:
obtaining, by a computing system that includes one or more processors and memory, camera data that includes video content of a real world scene;
analyzing, by the computing system, the camera data to determine one or more candidate objects included in the real world scene;
analyzing, by the computing system, features of the one or more candidate objects to determine that a plant is included in the real world scene;
analyzing, by the computing system, at least one of one or more leaf features of the plant, one or more flower features of the plant, or one or more dimensions of the plant to determine a classification of the plant;
determining, by the computing system and based on the classification of the plant, one or more care instructions for the plant; and
providing, by the computing system, the one or more care instructions for the plant to a user device that corresponds to a user associated with the plant.

11. The method of claim 10, comprising:
determining, by the computing system, a location of the plant based on at least one of geographic positioning system information of the user device, real world coordinates of the plant, or one or more additional objects included in the real world scene.

12. The method of claim 11, comprising:
determining, by the computing system, that the plant is included in a plant inventory of the user based on the location of the plant and the classification of the plant; and
responsive to determining that the plant is included in the plant inventory, sending, by the computing system, information indicating one or more plant care events to the user device.

13. The method of claim 11, comprising:
determining, by the computing system, that the plant is absent from a plant inventory of the user based on the location of the plant and the classification of the plant; and
causing, by the computing system, one or more user interfaces to be displayed including a user interface element to add the plant to the plant inventory.

14. The method of claim 10, wherein the plant is a first plant, and the method comprises:
analyzing, by the computing system, additional features of an additional candidate object of the one or more candidate objects to determine that a second plant is included in the real world scene;
analyzing, by the computing system, at least one of one or more additional leaf features of the second plant, one or more additional flower features of the second plant, or one or more additional dimensions of the second plant to determine an additional classification of the second plant; and
determining, by the computing system and based on the additional classification of the second plant, one or more care instructions for the second plant.

15. The method of claim 14, comprising:
analyzing, by the computing system, object data that corresponds to the camera data, the object data indicating features of one or more objects included in the real world scene; and
analyzing, by the computing system, the object data using one or more plant care detection models to determine that the one or more objects include at least one of a watering implement or a pruning tool.

16. The method of claim 15, comprising:
analyzing, by the computing system, object motion data that corresponds to the camera data and indicates motion of at least one of the watering implement, a pruning tool, a human appendage grasping the watering implement, or a human appendage grasping the pruning tool; and
determining, by the computing system using the one or more plant care detection models and based on the motion of at least one of the watering implement, the pruning tool, the human appendage grasping the watering implement, or the human appendage grasping the pruning tool, that a plant care event has taken place.

17. The method of claim 16, comprising:
determining, by the computing system, that the plant care event has occurred within a threshold proximity of the first plant; and
updating, by the computing system, a plant inventory with respect to the first plant to indicate that the plant care event has taken place with respect to the first plant.

18. A computing apparatus comprising:
one or more processors; and
memory storing computer-readable instructions that, when executed by the one or more processors, cause the one or more processors to perform operations comprising:
obtaining camera data that includes video content of a real world scene;
analyzing the camera data to determine one or more candidate objects included in the real world scene;
analyzing features of the one or more candidate objects to determine that a plant is included in the real world scene;
analyzing at least one of one or more leaf features of the plant, one or more flower features of the plant, or one or more dimensions of the plant to determine a classification of the plant;
determining, based on the classification of the plant, one or more care instructions for the plant; and
providing the one or more care instructions for the plant to a user device that corresponds to a user associated with the plant.

19. The computing apparatus of claim 18, wherein the memory stores additional computer-readable instructions that, when executed by the one or more processors, cause the one or more processors to perform additional operations comprising:
obtaining sensor data indicating an amount of ambient light in a current location of the plant;
determining a time of day corresponding to the sensor data;
determining, based on the amount of ambient light and the time of day, that the current location of the plant lacks sufficient ambient light for the plant;
obtaining additional sensor data indicating an additional amount of ambient light in an additional location;
determining a time of day corresponding to the additional sensor data;
determining, based on the additional amount of ambient light and the time of day, that the additional location provides sufficient ambient light for the plant; and
generating a recommendation to move the plant from the current location to the additional location.

20. The computing apparatus of claim 18, wherein the memory stores additional computer-readable instructions that, when executed by the one or more processors, cause the one or more processors to perform additional operations comprising:
analyzing one or more features of the plant to determine that a disease is present with respect to the plant;
determining one or more additional care instructions for the plant based on the disease being present with respect to the plant; and
providing the one or more additional care instructions to the user device.
